(19) United States
(12) Patent Application Publication
(10) Pub. No.: US 2026/0296913 A1
(43) Pub. Date: Oct. 1, 2026

(54) ELECTRODE, SOLID OXIDE CELL INCLUDING THE SAME, AND METHOD OF PREPARING SOLID OXIDE CELL

(71) Applicant: SAMSUNG ELECTRO-MECHANICS CO., LTD., Suwon-si (KR)

(72) Inventors: Doh Won Jung, Suwon-si (KR); Jusik Kim, Suwon-si (KR); Seungbok Lee, Suwon-si (KR); Sand Min JI, Suwon-si (KR); Bokkyu Choi, Suwon-si (KR)

(21) Appl. No.: 19/578,514

(22) Filed: Mar. 25, 2026

(30) Foreign Application Priority Data
Mar. 26, 2025 (KR) 10-2025-0039050
Jun. 27, 2025 (KR) 10-2025-0086300

(51) Int. Cl. C01G 51/66; C01G 49/00; C25B 1/04; C25B 11/031; C25B 11/077; C25B 13/05; H01M 4/86; H01M 4/88; H01M 4/90; H01M 8/10; H01M 8/12

(52) U.S. Cl. CPC C01G 51/66; C01G 49/0054; C25B 1/04; C25B 11/031; C25B 11/0773; C25B 13/05; H01M 4/8652; H01M 4/8882; H01M 4/9033; H01M 8/10; C01P 2002/72; C01P 2004/03; C01P 2004/61; C01P 2006/40; H01M 2008/1293

(57) ABSTRACT

An electrode including a composite conductor, a solid oxide cell including the electrode, and a method of preparing a solid oxide cell are disclosed. The composite conductor includes a first mixed conductor including a first metal oxide having a perovskite structure, and a second mixed conductor including a second metal oxide having a perovskite structure. The ionic conductivity of the first mixed conductor is greater than that of the second mixed conductor, and electronic conductivity of the second mixed conductor is greater than that of the first mixed conductor.

### CROSS-REFERENCE TO RELATED APPLICATION

This application claims priority to Korean Patent Application Nos. 10-2025-0039050, filed on Mar. 26, 2025, and 10-2025-0086300, filed on Jun. 27, 2025 in the Korean Intellectual Property Office, and all the benefits accruing therefrom under 35 U.S.C. § 119, the disclosures of which in their entirety are incorporated by reference herein.

### BACKGROUND

### 1. Field

The disclosure relates to an electrode, a solid oxide cell including the electrode, and a method of preparing the solid oxide cell.

### 2. Description of the Related Art

Solid oxide cells can operate in a fuel-cell mode in which fuel is oxidized and air is reduced to generate electricity. Solid oxide cells can also operate in an electrolysis-cell mode in which water is electrolyzed to produce hydrogen. During operation of the solid oxide cell in the electrolysis-cell mode degradation of the air electrode of the solid oxide cell may occur.

### SUMMARY

Provided is a novel electrode that provides improved structural stability and improved conversion efficiency.

Provided is a solid oxide cell including the electrode.

Provided is a method of preparing the solid oxide cell.

According to an aspect of the disclosure, an electrode includes a composite conductor, the composite conductor including:
a first mixed conductor containing a first metal oxide having a perovskite structure, and
a second mixed conductor containing a second metal oxide having a perovskite structure,
wherein the ionic conductivity of the first mixed conductor is greater than the ionic conductivity of the second mixed conductor, and the electronic conductivity of the second mixed conductor is greater than the electronic conductivity of the first mixed conductor.

According to another aspect of the disclosure, a solid oxide cell includes:
an air electrode; a fuel electrode; and a solid electrolyte layer between the air electrode and the fuel electrode,
wherein at least one of the air electrode and the fuel electrode includes a composite conductor,
wherein the composite conductor includes a first mixed conductor containing a first metal oxide having a perovskite structure, and a second mixed conductor containing a second metal oxide having a perovskite structure,
wherein the ionic conductivity of the first mixed conductor is greater than the ionic conductivity of the second mixed conductor, and the electronic conductivity of the second mixed conductor is greater than the electronic conductivity of the first mixed conductor.

According to another aspect of the disclosure, a method of preparing a solid oxide cell includes:
providing a composition including a first metal oxide having a perovskite structure and a second metal oxide having a perovskite structure;
applying the composition to a surface of a first stack including a fuel electrode and a solid electrolyte layer, the surface with the applied composition being adjacent to the solid electrolyte layer, to form a second stack; and
heat-treating the second stack to provide the solid oxide cell, the solid oxide cell having an air electrode including a composite conductor,
wherein the composite conductor includes a first mixed conductor including the first metal oxide and a second mixed conductor including the second metal oxide,
the ionic conductivity of the first mixed conductor is greater than the ionic conductivity of the second mixed conductor, and
the electronic conductivity of the second mixed conductor is greater than the electronic conductivity of the first mixed conductor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of an electrode according to an embodiment;

FIG. 2 is a schematic cross-sectional view of a solid oxide cell according to an embodiment;

FIG. 3 is a schematic cross-sectional view of a solid oxide cell according to an embodiment;

FIG. 4 is an exploded perspective view of a solid oxide cell stack according to an embodiment;

FIG. 5A is an XRD spectrum of a first mixed conductor prepared in Preparation Example 1;

FIG. 5B is an XRD spectrum of a first mixed conductor prepared in Preparation Example 1A;

FIG. 5C is an XRD spectrum of a first mixed conductor prepared in Preparation Example 2;

FIG. 5D is an XRD spectrum of a second mixed conductor prepared in Preparation Example 3;

FIG. 5E is an XRD spectrum of a second mixed conductor prepared in Preparation Example 4;

FIG. 6 is a schematic diagram illustrating a crystal structure of a mixed conductor including a metal oxide with a perovskite structure, prepared in Preparation Examples 3 and 4;

FIG. 7A is XRD spectra of a first mixed conductor prepared in Preparation Example 2, a second mixed conductor prepared in Preparation Example 4, a room-temperature mixture thereof, and a sintered product of the mixture, sintered in an air atmosphere at 950° C. for 2 hours;

FIG. 7B is XRD spectra of a first mixed conductor prepared in Preparation Example 2, a second mixed conductor prepared in Preparation Example 5, a room-temperature mixture thereof, and a sintered product of the mixture, sintered in an air atmosphere at 950° C. for 2 hours;

FIG. 8A is a scanning electron microscope image of a cross-section of a solid oxide cell prepared in Example 3;

FIG. 8B is a partially enlarged view of FIG. 8A;

FIG. 9A is a scanning electron microscope image of a cross-section of a solid oxide cell prepared in Comparative Example 4;

FIG. 9B is a partially enlarged view of FIG. 9A;

FIG. 10 is a graph illustrating changes in voltage over time of a solid oxide cell of Example 4; and

FIG. 11 is a graph illustrating current density versus voltage of solid oxide cells prepared in Example 3 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Various embodiments are illustrated in the accompanying drawings. However, the inventive concept may be embodied in many other forms and should not be construed as limited to the embodiments described in the present specification. Rather, these embodiments are provided so that the present disclosure may be thorough and complete and so that those of ordinary skill in the art may fully understand the scope of the inventive concept. The same reference numerals denote identical components.

When a component is described as being “on” another component, it may be directly on that other component or an additional component may be interposed therebetween. In contrast, when a component is described as being “directly on” another component, no component is interposed therebetween.

Terms such as “first,” “second,” and “third” may be used herein to describe various components, elements, regions, layers, and/or sections, but those components, elements, regions, layers, and/or sections are not limited by those terms. These terms are used only to distinguish one component, element, region, layer, or section from another component, element, region, layer, or section. Accordingly, a first component, element, region, layer, or section described below may be referred to as a second component, element, region, layer, or section without departing from the teachings of the present specification.

The terminology used herein is for the purpose of describing particular embodiments only and is not intended to limit the inventive concept. The singular forms used herein are intended to include plural forms encompassing “at least one,” unless the context clearly indicates otherwise. The phrase “at least one” must not be construed as limiting to the singular. As used in the present specification, the term “and/or” encompasses any and all combinations of one or more items in the listed elements. The terms “comprises” and/or “comprising” as used in the detailed description specify the presence of the stated features, regions, integers, steps, operations, components, and/or elements, and do not preclude the presence or addition of one or more other features, regions, integers, steps, operations, components, elements, and/or groups thereof.

Unless otherwise defined, all terms (including technical and scientific terms) used in the present specification have the same meanings as those commonly understood by one of ordinary skill in the art to which the present disclosure pertains. Terms defined in generally used dictionaries should be interpreted as having meanings consistent with the context of the relevant art and the present disclosure and should not be interpreted in an idealized or excessively formal sense.

Illustrative embodiments are described herein with reference to cross-sectional views that are schematic illustrations of idealized embodiments. Accordingly, variations from the illustrated shapes are to be expected, for example, as a result of manufacturing techniques and/or tolerances. Therefore, the embodiments described herein should not be construed as limited to the particular shapes of regions illustrated in the present specification, but should include variations in shapes that result, for example, from manufacturing. For instance, a region depicted or described as flat may typically exhibit roughness and/or nonlinear features. In addition, angles depicted as sharp may be rounded. Consequently, the regions shown in the drawings are inherently schematic, and their shapes are not intended to illustrate the exact shapes of the regions or to limit the scope of the claims.

“Group” denotes a group of the Periodic Table according to the 1-18 group classification system of the International Union of Pure and Applied Chemistry (IUPAC).

In the present specification, “particle size” indicates the average diameter when the particles are spherical and the average major-axis length when the particles are nonspherical. The particle size may be measured using a particle size analyzer (PSA). The term “particle size” refers, for example, to an average particle size. The “average particle size” is, for example, the median particle diameter D50. Alternatively, “average particle size” is, for example, the arithmetic mean particle size.

As used in the present disclosure, “mixed conductor” refers to a material that has ionic conductivity with respect to oxygen ions (O²⁻) or protons (H⁺) and has electronic conductivity with respect to electrons. For example, a “mixed conductor” refers to a material having an ionic conductivity of 0.001 S/cm or more at 700° C. and an electronic conductivity of 0.01 S/cm or more at 700° C. The ionic conductivity or electronic conductivity of the mixed conductor may be measured by, for example, AC impedance spectroscopy, a DC polarization method (or Hebb-Wagner Polarization Method), or the like.

In the present disclosure, the term “metal” may include both metals and metalloids such as silicon and germanium, whether in elemental or ionic form.

In the present disclosure, the term “alloy” means a metallic material comprising two or more elements, at least one of which is a metal as defined herein.

In the present disclosure, the term “fuel electrode” means an electrode that receives a fluid containing a fuel such as hydrogen in the fuel-cell mode of a solid oxide cell.

In the present disclosure, the term “fuel electrode” means an electrode that receives a fluid containing a fuel such as water (vapor) or carbon dioxide in the electrolysis-cell mode of a solid oxide cell. In the electrolysis-cell mode of a solid oxide cell, the term “fuel electrode” means feedstock electrode, reactant electrode or steam/CO₂ electrode.

In the present disclosure, the terms “air electrode” and “oxygen electrode” mean an electrode that receives a fluid containing oxygen in the fuel-cell mode of a solid oxide cell. The fluid containing oxygen may be, for example, air.

In the present disclosure, the terms “air electrode” and “oxygen electrode” mean an electrode at which a fluid containing oxygen is generated in the electrolysis-cell mode of a solid oxide cell.

In the present disclosure, the terms “positive electrode” and “cathode” mean an electrode at which reduction of oxygen occurs in the fuel-cell mode of a solid oxide cell.

In the present disclosure, the terms “negative electrode” and “anode” mean an electrode at which oxidation of the fuel occurs in the fuel-cell mode of a solid oxide cell.

In the present disclosure, the terms “negative electrode” and “cathode” mean an electrode at which reduction of fuel (e.g., feedstock, reactants, steam or CO₂) occurs by the electrons supplied from external power supply in the electrolysis-cell mode of a solid oxide cell.

In the present disclosure, the terms “positive electrode” and “anode” mean an electrode at which oxidation of oxygen ions or the like occurs by the current supplied from external power supply in the electrolysis-cell mode of a solid oxide cell.

Although specific embodiments have been described, alternatives, modifications, variations, improvements, and substantial equivalents that are not currently or reasonably foreseeable may occur to the applicant or to those skilled in the art. Accordingly, the appended claims, which may be filed and amended, are intended to encompass all such alternatives, modifications, variations, improvements, and substantial equivalents.

Hereinafter, an electrode according to an embodiment, a solid oxide cell including the electrode, and a method of preparing the solid oxide cell will be described in further detail.

During operation of a solid oxide cell in electrolysis mode, a high oxygen partial pressure in local regions inside the air electrode may cause formation of pores in the air electrode and/or a change in the stoichiometry of the air electrode. The pore formation and/or stoichiometry change in the air electrode may reduce active reaction sites in the air electrode over time, thereby increasing the overpotential in the solid oxide cell. The increased overpotential may further raise the local oxygen partial pressure in the air electrode over time, which may cause delamination between the air electrode and the solid electrolyte layer. Moreover, residual stress can be generated due to the difference in thermal expansion coefficients between the air electrode and the solid electrolyte layer. The residual stress can increase the delamination between the air electrode and the solid electrolyte layer. Accordingly, there is a need for an air electrode that can provide improved structural stability by suppressing delamination between the air electrode and the solid electrolyte layer in a solid oxide cell, thereby suppressing degradation of the air electrode. In addition, there is a need for an air electrode that can provide improved conversion efficiency by reducing internal resistance within the air electrode.

### Electrode

An electrode according to an embodiment is an electrode including a composite conductor, and the composite conductor includes a first mixed conductor including, or consisting of, a first metal oxide having a perovskite structure and a second mixed conductor including, or consisting of, a second metal oxide having a perovskite structure. An ionic conductivity of the first mixed conductor is greater than an ionic conductivity of the second mixed conductor. An electronic conductivity of the second mixed conductor is greater than an electronic conductivity of the first mixed conductor.

The electrode may include the composite conductor, the composite conductor may include the first mixed conductor and the second mixed conductor, and the overall ionic conductivity of the electrode may be improved because the first mixed conductor has a greater ionic conductivity than the second mixed conductor, and the overall electronic conductivity of the electrode may be improved because the second mixed conductor has a greater electronic conductivity than the first mixed conductor. Because the composite conductor includes both the first mixed conductor and the second mixed conductor, the composite conductor may simultaneously provide improved ionic conductivity and electronic conductivity. Because the composite conductor simultaneously provides improved ionic conductivity and electronic conductivity, an increase in the local oxygen partial pressure within the electrode may be suppressed. By suppressing the increase in the local oxygen partial pressure within the electrode, delamination between the electrode and the solid electrolyte layer may be suppressed. By suppressing delamination between the electrode and the solid electrolyte layer, degradation of the electrode may be suppressed, and consequently, the structural stability of the electrode may be improved.

In addition, because the composite conductor simultaneously provides improved ionic conductivity and electronic conductivity, the internal resistance within the electrode may be reduced, and the reversibility of the electrode reaction may be improved. In a solid oxide cell including an electrode that provides improved reversibility of the electrode reaction, the current density may be increased. Consequently, in such an electrode, the energy conversion efficiency may be improved.

A mixed conductor is a conductor that simultaneously provides ionic conductivity and electronic conductivity. A mixed conductor is distinguished from an ion conductor, which provides ionic conductivity but has substantially no electronic conductivity, and is distinguished from an electron conductor, which has electronic conductivity but has substantially no ionic conductivity. For example, an ion conductor is substantially an electron insulator. For example, an ion conductor provides very low electronic conductivity at 700° C. For example, the electronic conductivity of the ion conductor at 700° C. may be 1/1000 or less of the electronic conductivity of the mixed conductor.

An electron conductor is substantially an ion insulator. For example, an electron conductor provides very low ionic conductivity at 700° C. For example, the ionic conductivity of the electron conductor at 700° C. may be 1/1000 or less of the ionic conductivity of the mixed conductor.

For example, the ionic conductivity of the first mixed conductor at 700° C. may be 0.2 Siemens per centimeter (S/cm) or more, 0.3 S/cm or more, or 0.4 S/cm or more. For example, the ionic conductivity of the first mixed conductor at 700° C. may be about 0.2 S/cm to about 10 S/cm, about 0.3 S/cm to about 5 S/cm, or about 0.4 S/cm to about 1 S/cm. Because the first mixed conductor has an ionic conductivity in the aforementioned range, the electrode may provide improved ionic conductivity.

The ionic conductivity of the first mixed conductor and the second mixed conductor may be measured by one of two methods: AC impedance spectroscopy, or a DC polarization method (or Hebb-Wagner Polarization Method) as long as the same method is used to measure the ionic conductivity of the first mixed conductor and the second mixed conductor. The measurements are made prior to forming the composite conductor.

The electronic conductivity of the first mixed conductor and the second mixed conductor may be measured by one of two methods: AC impedance spectroscopy, or a DC polarization method (or Hebb-Wagner Polarization Method) as long as the same method is used to measure the electronic conductivity of the first mixed conductor and the second mixed conductor. The measurements are made prior to forming the composite conductor.

For example, the difference in ionic conductivity between the first mixed conductor and the second mixed conductor at 700° C. may be 0.1 S/cm or more, 0.2 S/cm or more, or 0.3 S/cm or more. Because the first mixed conductor has a difference in ionic conductivity in the aforementioned range compared to the second mixed conductor, the ionic conductivity of the electrode may be more effectively improved.

For example, the electronic conductivity of the first mixed conductor at 700° C. may be 0.01 S/cm or more, 0.1 S/cm or more, or 1 S/cm or more. For example, the electronic conductivity of the first mixed conductor at 700° C. may be about 0.01 S/cm to about 300 S/cm, about 0.1 S/cm to about 200 S/cm, about 1 S/cm to about 100 S/cm, about 10 S/cm to about 50 S/cm, or about 20 S/cm to about 40 S/cm. Because the first mixed conductor has an electronic conductivity in the aforementioned range, the electrode can simultaneously provide excellent ionic conductivity and electronic conductivity. Because the first mixed conductor has an electronic conductivity in the aforementioned range in addition to ionic conductivity, the first mixed conductor may act as a mixed conductor.

For example, the electronic conductivity of the second mixed conductor at 700° C. may be 100 S/cm or more, 200 S/cm or more, or 500 S/cm or more. For example, the electronic conductivity of the second mixed conductor at 700° C. may be about 100 S/cm to about 10,000 S/cm, about 200 S/cm to about 5,000 S/cm, about 500 S/cm to about 3,000 S/cm, or about 500 S/cm to about 2,000 S/cm. Because the second mixed conductor has an electronic conductivity in the aforementioned range, the electrode can provide improved electronic conductivity.

For example, the difference in electronic conductivity between the second mixed conductor and the first mixed conductor at 700° C. may be 50 S/cm or more, 100 S/cm or more, or 200 S/cm or more. Because the second mixed conductor has a difference in electronic conductivity in the aforementioned range compared to the first mixed conductor, the electronic conductivity of the electrode may be more effectively improved.

For example, the ionic conductivity of the second mixed conductor at 700° C. may be 0.001 S/cm or more, 0.01 S/cm or more, or 0.1 S/cm or more. For example, the ionic conductivity of the second mixed conductor at 700° C. may be about 0.001 S/cm to about 10 S/cm, about 0.01 S/cm to about 5 S/cm, or about 0.1 S/cm to about 1 S/cm, about 0.1 S/cm to about 0.5 S/cm, or about 0.1 S/cm to about 0.3 S/cm. Because the second mixed conductor has an ionic conductivity in the aforementioned range, the electrode may simultaneously provide excellent ionic conductivity and electronic conductivity. Because the second mixed conductor has an ionic conductivity in the aforementioned range in addition to electronic conductivity, the second mixed conductor may act as a mixed conductor.

For example, the thermal expansion coefficient of the first mixed conductor may be lower than the thermal expansion coefficient of the second mixed conductor. For example, the ratio TEC1/TEC2 of the thermal expansion coefficient of the first mixed conductor (TEC1) to the thermal expansion coefficient of the second mixed conductor (TEC2) may be 0.99 or less, 0.95 or less, or 0.9 or less. Because the first mixed conductor has a lower thermal expansion coefficient than the second mixed conductor, the electrode may have a reduced thermal expansion coefficient. Because the electrode has a reduced thermal expansion coefficient, the generation of residual stress due to the difference in thermal expansion coefficients between the air electrode and the solid electrolyte layer may be reduced. Due to this reduced generation of residual stress, delamination between the air electrode and the solid electrolyte layer may be suppressed. By suppressing the generation of residual stress between the air electrode and the solid electrolyte layer, degradation of the electrode may be suppressed. Consequently, the electrode may provide improved structural stability. For example, in a solid oxide cell including such an electrode, a stable cell voltage may be provided even after long-term operation. A solid oxide cell including such an electrode may provide improved durability.

For example, the thermal expansion coefficient (TEC1) of the first mixed conductor may be 20×10⁻⁶/K or less, 19×10⁻⁶/K or less, or 18×10⁻⁶/K or less. For example, the TEC1 of the first mixed conductor may be about 10×10⁻⁶/K to about 20×10⁻⁶/K, about 13×10⁻⁶/K to about 19×10⁻⁶/K, or about 15×10⁻⁶/K to about 18×10⁻⁶/K. Because the first mixed conductor has a thermal expansion coefficient in the aforementioned range, delamination between the electrode and the solid electrolyte layer may be effectively suppressed. The structural stability of a solid oxide cell including the electrode may be improved. For example, the thermal expansion coefficients of the first mixed conductor and the second mixed conductor may be measured according to ASTM E228 using a dilatometer.

For example, the oxygen vacancy content of the first metal oxide may be greater than the oxygen vacancy content of the second metal oxide. For example, the oxygen vacancy (more precisely, oxygen vacancy content) may be represented by δ in the first metal oxide represented by Formulas 1 and 2 to be described below and in the second metal oxide represented by Formulas 3 and 4 to be described below. Because the first metal oxide has an increased oxygen vacancy content compared to the second metal oxide, for example, the first metal oxide may have an increased carrier concentration compared to the second metal oxide. Therefore, the first mixed conductor including the first metal oxide may provide improved ionic conductivity compared to the second mixed conductor including the second metal oxide.

For example, the first mixed conductor and the second mixed conductor may have a particle form. For example, the particle form may include spherical particles, ellipsoidal particles, polyhedral particles, acicular particles, plate-like particles, rod-like particles, amorphous particles, or a combination thereof. Because the first mixed conductor and the second mixed conductor have a particle form, pores may be formed between the first mixed conductor and the second mixed conductor. Therefore, an electrode including the first mixed conductor and the second mixed conductor may have porosity.

For example, the particle size of the first mixed conductor may be larger than the particle size of the second mixed conductor. For example, the particle size of the first mixed conductor and/or the particle size of the second mixed conductor may be the average particle size of particles read automatically by software or read manually from a scanning electron microscope image measured for the first mixed conductor powder and/or the second mixed conductor powder. For example, the average particle size may be the arithmetic mean particle size. Alternatively, the particle size of the first mixed conductor and/or the second mixed conductor may be the average particle size measured by a laser diffraction method. For example, the average particle size may be the D50 particle size.

For example, the ratio PD2/PD1 of the particle size of the second mixed conductor (PD2) to the particle size of the first mixed conductor (PD1) may be 0.95 or less, 0.90 or less, or 0.8 or less. For example, the ratio PD2/PD1 of the particle size of the second mixed conductor (PD2) to the particle size of the first mixed conductor (PD1) may be about 0.5 to about 0.95, about 0.5 to about 0.9, about 0.5 to about 0.8, or about 0.6 to about 0.8. Because the ratio PD2/PD1 of the particle size of the second mixed conductor (PD2) to the particle size of the first mixed conductor (PD1) is in the aforementioned range, the first mixed conductor and the second mixed conductor may be more effectively packed within the electrode. Because the electrode has an increased packing density, an increased triple phase boundary (TPB) may be formed within the electrode. Because the electrode includes an increased TPB, the number of reaction sites for the electrode reaction is increased, and thereby the electrode may provide improved output or improved energy conversion efficiency.

For example, the particle size of the first mixed conductor may be 4 micrometers (μm) or less, 3 μm or less, 2 μm or less, 1.5 μm or less, or 1 μm or less. For example, the particle size of the first mixed conductor may be about 0.1 μm to about 4 μm, about 0.1 μm to about 3 μm, about 0.1 μm to about 2 μm, about 0.1 μm to about 1.5 μm, about 0.1 μm to about 1 μm, about 0.2 μm to about 4 μm, about 0.3 μm to about 4 μm, or about 0.4 μm to about 4 μm. Because the first mixed conductor has a particle size in the aforementioned range, an electrode including the first mixed conductor may provide further improved energy conversion efficiency.

For example, the particle size of the second mixed conductor may be 2 μm or less, 1.5 μm or less, or 1 μm or less. For example, the particle size of the second mixed conductor may be about 0.1 μm to about 2 μm, about 0.1 μm to about 1.5 μm, about 0.1 μm to about 1 μm, about 0.2 μm to about 1 μm, or about 0.3 μm to about 1 μm. Because the second mixed conductor has a particle size in the aforementioned range, an electrode including the second mixed conductor may provide further improved energy conversion efficiency.

For example, the particle size of the first mixed conductor may be 4 μm or less, and the particle size of the second mixed conductor may be 2 μm or less. For example, the particle size of the first mixed conductor may be 3 μm or less, and the particle size of the second mixed conductor may be 2 μm or less. For example, the particle size of the first mixed conductor may be 2 μm or less, and the particle size of the second mixed conductor may be 2 μm or less. For example, the particle size of the first mixed conductor may be 2 μm or less, and the particle size of the second mixed conductor may be 1.5 μm or less. For example, the particle size of the first mixed conductor may be 2 μm or less, and the particle size of the second mixed conductor may be 1 μm or less. For example, the particle size of the first mixed conductor may be 1.5 μm or less, and the particle size of the second mixed conductor may be 1.5 μm or less. For example, the particle size of the first mixed conductor may be 1 μm or less, and the particle size of the second mixed conductor may be 1 μm or less. Because the first mixed conductor and the second mixed conductor have particle sizes in these ranges, the triple phase boundary (TPB) formed within the electrode may be increased. Consequently, an electrode including the increased TPB may provide further improved energy conversion efficiency.

For example, a ratio of the first mixed conductor and the second mixed conductor, as a weight ratio, may be about 7:3 to about 3:7, about 6.5:3.5 to about 3.5:6.5, about 6:4 to about 4:6, or about 5.5:4.5 to about 4.5:5.5. Because the first mixed conductor and the second mixed conductor have a ratio in the aforementioned range, the electrode may simultaneously provide further improved ionic conductivity and electronic conductivity. Consequently, an electrode including the first and second mixed conductors may provide further improved energy conversion efficiency.

A composite conductor including the first mixed conductor and the second mixed conductor may be prepared by sintering a mixture of the first mixed conductor and the second mixed conductor. In a composite conductor including the first mixed conductor and the second mixed conductor, the first mixed conductor and the second mixed conductor may be composited with each other by chemical bonds at least at or near the interface of the two mixed conductors. A composite conductor including the first mixed conductor and the second mixed conductor may be distinguished from a simple mixture of the first mixed conductor and the second mixed conductor or a simple composition including the first mixed conductor, the second mixed conductor, and a binder that binds the first and second mixed conductors.

For example, in an XRD spectrum of the composite conductor, the peak positions of the composite conductor may be distinguished from the peak positions of a simple mixture of the first mixed conductor and the second mixed conductor.

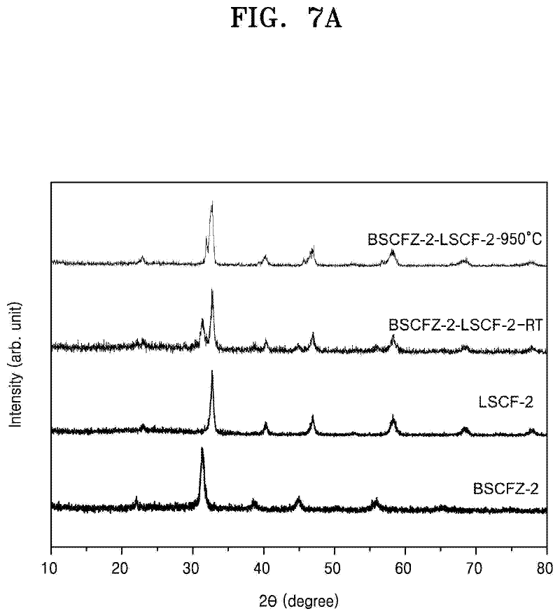

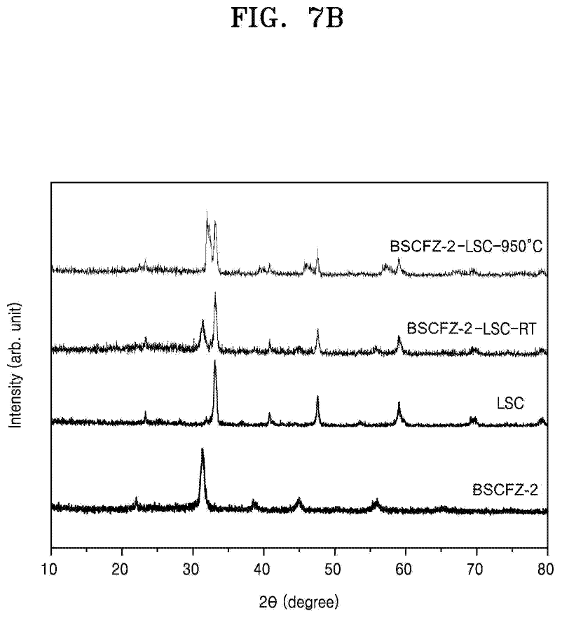

For example, referring to the XRD spectra shown in FIG. 7A, a first distance between a first peak appearing at a diffraction angle (2θ) of 30° to 35° originating from the first mixed conductor, BSCFZ, and a second peak appearing at a diffraction angle (2θ) of 30° to 35° originating from the second mixed conductor, LSCF, in the composite conductor obtained by heat-treating the first mixed conductor, BSCFZ, and the second mixed conductor, LSCF, at 950° C., has a smaller value than a second distance between the first peak appearing at a diffraction angle (2θ) of 30° to 35° originating from the first mixed conductor, BSCFZ, and the second peak appearing at a diffraction angle (2θ) of 30° to 35° originating from the second mixed conductor, LSCF, in a simple room-temperature mixture of the first mixed conductor, BSCFZ, and the second mixed conductor, LSCF. Accordingly, the XRD spectra data confirm that partial chemical bonds are formed between the first mixed conductor, BSCFZ, and the second mixed conductor, LSCF, and that the first and second mixed conductors, collectively, form a composite conductor.

For example, referring to the XRD spectra shown in FIG. 7B, a third distance between a first peak appearing at a diffraction angle (2θ) of 30° to 35° originating from the first mixed conductor, BSCFZ, and a third peak appearing at a diffraction angle (2θ) of 30° to 35° originating from the second mixed conductor, LSC, in the composite conductor obtained by heat-treating the first mixed conductor, BSCFZ, and the second mixed conductor, LSC, at 950° C., has a smaller value than a fourth distance between the first peak appearing at a diffraction angle (2θ) of 30° to 35° originating from the first mixed conductor, BSCFZ, and the third peak appearing at a diffraction angle (2θ) of 30° to 35° originating from the second mixed conductor, LSC, in a simple room-temperature mixture of the first mixed conductor, BSCFZ, and the second mixed conductor, LSC, and this result therefore showed that partial chemical bonds are formed between the first mixed conductor, BSCFZ, and the second mixed conductor, LSC, and that the first and second mixed conductors, collectively, form a composite conductor.

For example, the electrode may be free of an ion conductor. For example, the electrode may include the composite conductor but may not include an ion conductor that has ionic conductivity and is substantially an electron insulator. For example, the electrode may not include an ion conductor such as scandia-stabilized zirconia (SSZ), yttria-stabilized zirconia (YSZ), scandia-ceria-stabilized zirconia (SCSZ), scandia-ceria-yttria-stabilized zirconia (SCYSZ), scandia-ceria-ytterbia-stabilized zirconia (SCYbSZ), ceria such as CeO₂, a bismuth-based oxide such as Bi₂O₃, or a lanthanum gallate-based oxide such as LaGaO₃.

For example, the first metal oxide may include a first-1 element and a first-2 element, which occupy cuboctahedral sites of the perovskite structure, and may include a first-3 element and a first-4 element, which occupy octahedral sites of the perovskite structure. Alternatively, for example, the first metal oxide may include a first-1 element and a first-2 element, which occupy cuboctahedral sites of the perovskite structure, and may include a first-3 element, a first-4 element, and a first-5 element, which occupy octahedral sites of the perovskite structure.

For example, the first-1 element and the first-2 element may independently include an element belonging to Group 2 of the Periodic Table and having an atomic weight of 30 or more. For example, the first-1 element and the first-2 element may independently include Ca, Sr, Ba, Ra, or a combination thereof. For example, the oxidation state of the first-1 element and the oxidation state of the first-2 element may independently be +1 or +2.

For example, the first-3 element may include an element belonging to Group 9 of the Periodic Table. For example, the first-3 element may include Co, Rh, Ir, or a combination thereof. For example, the oxidation state of the first-3 element may include +2, +3, +4, +5, or a combination thereof.

For example, the first-4 element and the first-5 element may independently include an element belonging to Group 3 to Group 8 or Group 10 to Group 12 of the Periodic Table. For example, the first-4 element and the first-5 element may independently include Fe, Zn, Mn, Yb, Ni, Cu, Ti, Ho, or a combination thereof. For example, the oxidation state of the first-4 element and the oxidation state of the first-5 element may independently, for example, include +2, +3, +4, +5, or a combination thereof.

For example, the content of the first-4 element or the first-5 element, as a molar ratio, may be 0.5 or less, 0.4 or less, 0.3 or less, or 0.2 or less, each with respect to the total amount of the first-3 element, the first-4 element, and the first-5 element.

For example, the content of the first-3 element, as a molar ratio, may be 0.5 or more, 0.6 or more, 0.7 or more, or 0.8 or more with respect to the total amount of the first-3 element, the first-4 element, and the first-5 element.

Because the first metal oxide includes such a first-1 element, first-2 element, first-3 element, first-4 element, and optionally a first-5 element, the first mixed conductor including the first metal oxide may simultaneously have ionic conductivity and electronic conductivity, while providing excellent ionic conductivity.

The first metal oxide may be represented by Formula 1:

M1ₐ₁M2_{b1}M3_{c1}M4_{d1}M5ₑ₁O_{3-δ} Formula 1

In the formula,
0.01≤a1≤0.8, 0.01≤b1≤0.8, 0.5≤c1≤0.9, 0.1≤d1≤0.3, 0≤e1≤0.2, and 0≤δ<1,
M1 and M2 may each independently be an element belonging to Group 2 of the Periodic Table and have an atomic weight of 30 or more,
M3 may be an element belonging to Group 9 of the Periodic Table,
M4 and M5 may each independently be an element belonging to Groups 3 to 8 or Groups 10 to 12 of the Periodic Table, and
δ may be an oxygen vacancy.

In Formula 1, for example, 0.05≤a1≤0.8, 0.05≤b1≤0.8, 0.55≤c1≤0.9, 0.1≤d1≤0.25, 0≤e1≤0.15, and 0≤δ<0.8. For example, 0.05≤a1≤0.7, 0.05≤b1≤0.7, 0.55≤c1≤0.9, 0.1≤d1≤0.25, 0≤e1≤0.15, and 0≤δ<0.8. For example, 0.05≤a1≤0.6, 0.05≤b1≤0.6, 0.55≤c1≤0.9, 0.1≤d1≤0.25, 0≤e1≤0.15, and 0≤δ<0.8. 0.05≤a1≤0.5, 0.05≤b1≤0.5, 0.55≤c1≤0.9, 0.1≤d1≤0.25, 0≤e1≤0.15, and 0≤δ<0.8. For example, 0.1≤a1≤0.5, 0.1≤b1≤0.5, 0.6≤c1≤0.9, 0.1≤d1≤0.22, 0≤e1≤0.1, and 0≤δ<0.5. For example, 0.2≤a1≤0.5, 0.2≤b1≤0.5, 0.7≤c1≤0.9, 0.1≤d1≤0.2, 0≤e1≤0.05, and 0≤δ<0.3.

In Formula 1, for example, M1 and M2 may independently include Ca, Sr, Ba, Ra, or a combination thereof. In Formula 1, for example, M3 may include Co, Rh, Ir, or a combination thereof. In Formula 1, for example, M4 and M5 may independently include Fe, Zn, Mn, Yb, Ni, Cu, Ti, Ho, or a combination thereof.

The first metal oxide may be represented by Formula 2:

Baₐ₂Sr_{b2}Co_{c2}Fe_{d2}Znₑ₂O_{3-δ} Formula 2

In the formula,
0.1≤a2≤0.8, 0.1≤b2≤0.8, 0.5≤c2≤0.9, 0.1≤d2≤0.3, 0≤e2≤0.2, and 0≤δ<1.

In Formula 2, for example, 0.1≤a2≤0.8, 0.1≤b2≤0.8, 0.55≤c2≤0.9, 0.1≤d2≤0.25, 0≤e2≤0.15, and 0≤δ<0.8. For example, 0.1≤a2≤0.7, 0.1≤b2≤0.7, 0.55≤c2≤0.9, 0.1≤d2≤0.25, 0≤e2≤0.15, and 0≤δ<0.8. For example, 0.1≤a2≤0.6, 0.1≤b2≤0.6, 0.55≤c2≤0.9, 0.1≤d2≤0.25, 0≤e2≤0.15, and 0≤δ<0.8. For example, 0.1≤a2≤0.5, 0.1≤b2≤0.5, 0.6≤c2≤0.9, 0.1≤d2≤0.22, 0≤e2≤0.1, and 0≤δ<0.5. For example, 0.1≤a2≤0.5, 0.1≤b2≤0.5, 0.7≤c2≤0.9, 0.1≤d2≤0.2, 0≤e2≤0.05, and 0≤δ<0.3.

For example, the second metal oxide may include a second-1 element and a second-2 element, which occupy cuboctahedral sites of the perovskite structure, and may include a second-3 element occupying octahedral sites of the perovskite structure.

Alternatively, for example, the second metal oxide may include a second-1 element and a second-2 element, which occupy cuboctahedral sites of the perovskite structure, and may include a second-3 element and a second-4 element, which occupy octahedral sites of the perovskite structure.

For example, the second-1 element may include an element belonging to Group 3 of the Periodic Table. For example, the second-1 element may include a lanthanide element, Sc, Y, or a combination thereof. For example, the lanthanide element may include La, Pr, Nd, or a combination thereof. For example, the oxidation state of the second-1 element may include +2, +3, or a combination thereof.

For example, the second-2 element may include an element belonging to Group 2 of the Periodic Table and having an atomic weight of 30 or more. For example, the second-2 element may each independently include Ca, Sr, Ba, Ra, or a combination thereof. For example, the oxidation state of the second-2 element may be +1 or +2.

For example, the second-3 element may include an element belonging to Group 9 of the Periodic Table. For example, the second-3 element may include Co, Rh, Ir, or a combination thereof. For example, the oxidation state of the second-3 element may include +2, +3, +4, +5, or a combination thereof.

For example, the second-4 element may include an element belonging to Group 3 to Group 8 or Group 10 to Group 12 of the Periodic Table. For example, the second-4 element may include Fe, Zn, Mn, Yb, Ni, Cu, Ti, Ho, or a combination thereof. For example, the oxidation state of the second-4 element may include +2, +3, +4, +5, or a combination thereof.

For example, the content of the second-1 element may be greater than the content of the second-2 element.

The content of the second-1 element, as a molar ratio, may be greater than 0.5, 0.55 or more, or 0.6 or more with respect to the total amount of the second-1 element and the second-2 element.

The content of the second-2 element, as a molar ratio, may be less than 0.5, 0.45 or less, or 0.4 or less with respect to the total amount of the second-1 element and the second-2 element.

Because the second metal oxide includes such a second-1 element, second-2 element, second-3 element, and optionally a second-4 element, the second mixed conductor including the second metal oxide may simultaneously have ionic conductivity and electronic conductivity, while providing excellent electronic conductivity.

The second metal oxide may be represented by Formula 3:

M6ₐ₃M7_{b3}M8_{c3}M9_{d3}O_{3-δ} Formula 3

In the formula,
0.2≤a3≤0.8, 0.2≤b3≤0.8, 0.1≤c3≤1.0, 0≤d3≤0.9, and 0≤δ<1,
M6 may be an element belonging to Group 3 of the Periodic Table,
M7 may be an element belonging to Group 2 of the Periodic Table and having an atomic weight of 30 or more,
M8 may be an element belonging to Group 9 of the Periodic Table,
M9 may be an element belonging to Groups 3 to 8 or Groups 10 to 12 of the Periodic Table, and
δ may be an oxygen vacancy.

In Formula 3, for example, 0.3≤a3≤0.8, 0.2≤b3≤0.7, 0.1≤c3≤1.0, 0≤d3≤0.9, and 0≤δ<0.8. For example, 0.4≤a3≤0.8, 0.2≤b3≤0.6, 0.15≤c3≤1.0, 0≤d3≤0.85, and 0≤δ<0.5. For example, 0.5≤a3≤0.8, 0.2≤b3≤0.5, 0.2≤c3≤1.0, 0≤d3≤0.8, and 0≤δ<0.3.

In Formula 3, for example, M6 may include a lanthanide element, Sc, Y, or a combination thereof. For example, the lanthanide element may include La, Pr, Nd, or a combination thereof. In Formula 3, for example, M7 may include Ca, Sr, Ba, Ra, or a combination thereof. In Formula 3, M8 may include Co, Rh, Ir, or a combination thereof. In Formula 3, for example, M9 may include Fe, Zn, Mn, Ni, Cu, Ti, or a combination thereof. For example, the oxidation state of M9 may include +3, +4, +5, or a combination thereof. The second metal oxide may be represented by Formula 4:

Laₐ₄Sr_{b4}CO_{c4}Fe_{d4}O_{3-δ} Formula 4

In the formula,
0.2≤a4≤0.8, 0.2≤b4≤0.8, 0.1≤c4≤1.0, 0≤d4≤0.9, and 0≤δ<1.

In Formula 4, for example, 0.3≤a4≤0.8, 0.2≤b4≤0.7, 0.1≤c4≤1.0, 0≤d4≤0.9, and 0≤δ<0.8. For example, 0.4≤a4≤0.8, 0.2≤b4≤0.6, 0.15≤c4≤1.0, 0≤d4≤0.85, and 0≤δ<0.5. For example, 0.5≤a4≤0.8, 0.2≤b4≤0.5, 0.2≤c4≤1.0, 0≤d4≤0.8, and 0≤δ<0.3.

For example, the electrode may be used as a positive electrode, a negative electrode, a cathode, an anode, an air electrode, or a fuel electrode of an electrochemical cell. For example, the electrode may be an air electrode.

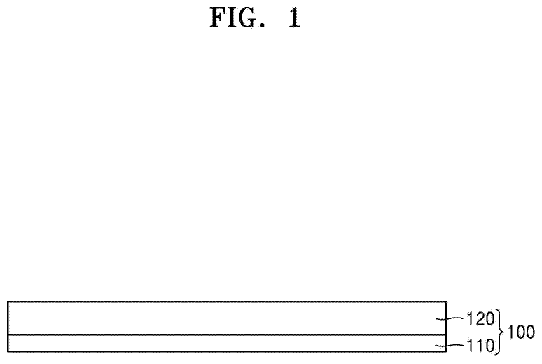

FIG. 1 is a schematic cross-sectional view of an air electrode according to an embodiment.

Referring to FIG. 1, the air electrode 100 may include an air electrode current collector 110 and an air electrode catalyst layer 120 disposed on the air electrode current collector 110. The air electrode catalyst layer 120 may include the aforementioned composite conductor.

The air electrode current collector 110 may be, for example, a porous conductor including a plurality of pores. The air electrode current collector 110 may include, for example, a metal mesh, a metal foam, a metal powder assembly, a porous carbon structure, or a combination thereof. The metal mesh, metal foam, or metal powder assembly may include, for example, stainless steel, nickel (Ni), cobalt (Co), manganese (Mn), aluminum (Al), indium (In), copper (Cu), magnesium (Mg), titanium (Ti), iron (Fe), zinc (Zn), germanium (Ge), silver (Ag), gold (Au), platinum (Pt), or alloys thereof. The metal mesh or metal foam may include a stainless-steel framework and a coating layer disposed on a surface of that framework, and the coating layer may include nickel (Ni), cobalt (Co), manganese (Mn), aluminum (Al), indium (In), copper (Cu), magnesium (Mg), titanium (Ti), iron (Fe), zinc (Zn), germanium (Ge), silver (Ag), gold (Au), platinum (Pt), or an alloy of each of the aforementioned metals.

The air electrode catalyst layer 120 includes the aforementioned composite conductor as a catalyst. The air electrode catalyst layer 120 may be formed by preparing an air electrode catalyst layer paste including a first metal oxide having a perovskite structure, a second metal oxide having a perovskite structure, and an organic vehicle, and then coating the paste on a substrate and sintering the coated substrate. For example, the organic vehicle may be a composition that includes a solvent, and optionally, further includes organic components such as a binder. The first mixed conductor including the first metal oxide and the second mixed conductor including the second metal oxide are collectively sintered to form a composite conductor. For example, the first mixed conductor and the second mixed conductor may form a composite conductor at an interface of the first mixed conductor and the second mixed conductor. For example, the composite conductor may form chemical bonds at the interface of the first mixed conductor and the second mixed conductor during the sintering process.

For example, the substrate may be the air electrode current collector 110 or a solid electrolyte layer (not shown). The composite conductor includes a first mixed conductor and a second mixed conductor having excellent ionic conductivity and electronic conductivity, respectively, and since the ionic conductivity of the first mixed conductor is greater than that of the second mixed conductor and the electronic conductivity of the second mixed conductor is greater than that of the first mixed conductor, the composite conductor may function as a catalyst for an oxygen reduction reaction and/or an oxygen evolution reaction in the air electrode. Because the composite conductor has improved structural stability, degradation of the air electrode catalyst layer 120 may be suppressed even after long-term operation. The durability of the air electrode 100 may be improved.

The air electrode catalyst layer 120 may further include a binder, a conductive agent, and the like.

The binder may include, for example, poly(vinylidene fluoride-hexafluoropropylene) copolymer (PVDF-HFP), polyvinylidene fluoride (PVDF), polyacrylonitrile (PAN), polymethyl methacrylate (PMMA), polytetrafluoroethylene (PTFE), polyacrylic acid (PAA), polyvinyl alcohol (PVA), carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber, fluorinated rubber, copolymers of the aforementioned materials, or a combination thereof. The binder content may be about 1 part by weight to about 10 parts by weight, or about 2 parts by weight to about 7 parts by weight, based on 100 parts by weight of the solid ion conductor (composite conductor). The binder may be partially or entirely removed by vaporization and/or carbonization during the sintering process of the air electrode catalyst layer 120. The binder may be omitted.

For example, the conductive agent may include a carbon-based conductive agent. For example, the carbon-based conductive agent may include carbon black, carbon fiber, graphite, carbon fluoride, or a combination thereof. For example, the carbon black may be acetylene black, Ketjen black, Super P carbon black, channel black, furnace black, lamp black, thermal black, or a combination thereof. The graphite may be natural graphite or artificial graphite. The air electrode catalyst layer 120 may further include a metal-based conductive agent, a metal oxide-based conductive agent, or a polymer-based conductive agent in addition to the aforementioned carbon-based conductive agent. For example, the metal-based conductive agent may be a metal fiber; a metal powder such as aluminum powder or nickel powder; a conductive metal oxide such as zinc oxide or potassium titanate; or a polyethylene derivative, and the like. The content of the conductive agent may be about 1 part by weight to about 10 parts by weight, or about 2 parts by weight to about 7 parts by weight, based on 100 parts by weight of the solid ion conductor (composite conductor). The conductive agent may be omitted.

The air electrode catalyst layer paste may include a solvent. For example, the solvent may include terpineol and the like, but is not limited thereto.

At the air electrode 100, depending on the operating mode, the oxygen reduction reaction (ORR) represented by the following Reaction Equation 1, the oxygen evolution reaction (OER) represented by the following Reaction Equation 2, or both of these reactions may occur.

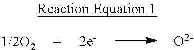

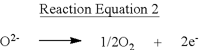

In the fuel-cell mode of a solid oxide cell, the oxygen reduction reaction may be performed at the air electrode. In the electrolysis-cell mode of a solid oxide cell, the oxygen evolution reaction may be performed at the air electrode. At the air electrode of a metal-air battery, the oxygen evolution reaction may be performed during charging, and the oxygen reduction reaction may be performed during discharging.

A solid oxide cell according to another embodiment may include: an air electrode; a fuel electrode; and a solid electrolyte layer disposed between the air electrode and the fuel electrode, wherein at least one of the air electrode and the fuel electrode includes the aforementioned composite conductor. The composite conductor may include a first mixed conductor containing a first metal oxide having a perovskite structure and a second mixed conductor containing a second metal oxide having a perovskite structure, the ionic conductivity of the first mixed conductor may be greater than the ionic conductivity of the second mixed conductor, and the electronic conductivity of the second mixed conductor may be greater than the electronic conductivity of the first mixed conductor.

The solid oxide cell may be, for example, a solid oxide fuel cell or a solid oxide electrolyzer cell.

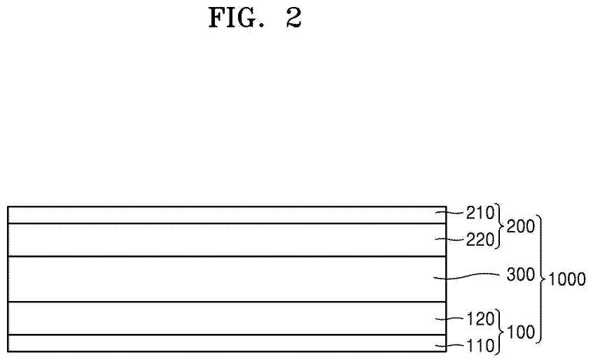

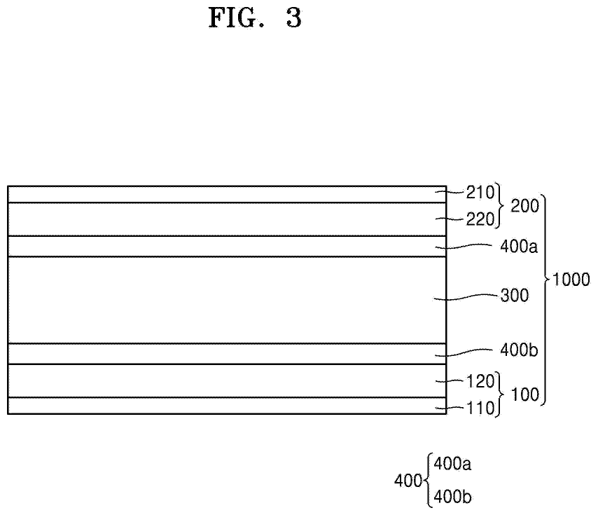

FIGS. 2 and 3 are a schematic diagram of a solid oxide cell 1000 according to an embodiment. The solid oxide cell may operate in both a fuel-cell mode, in which an oxygen reduction reaction occurs, and an electrolysis-cell mode, in which an oxygen evolution reaction occurs. For example, depending on the required conditions, electrical power may be generated in the fuel-cell mode, or fuel may be produced in the electrolysis-cell mode.

Referring to FIGS. 2 and 3, the solid oxide cell may include an air electrode 100, a fuel electrode 200, and a solid electrolyte layer 300 disposed between the air electrode 100 and the fuel electrode 200. The air electrode 100 may perform an oxygen reduction reaction and/or an oxygen evolution reaction. The air electrode 100 may include an air electrode current collector 110 and an air electrode catalyst layer 120. For a detailed description of the air electrode current collector 110 and the air electrode catalyst layer 120, refer to the aforementioned electrode.

The solid electrolyte layer 300 may be a solid oxide electrolyte layer. The solid electrolyte layer 300 may include a solid ion conductor, which may include, for example, an oxygen-ion conductor, a proton conductor, or a mixture thereof. The solid electrolyte layer 300 may include, as the oxygen-ion conductor, an oxygen ion-conducting metal oxide. The oxygen ion-conducting metal oxide may include, for example, rare-earth-doped ceria (RDC) such as NDC (neodymium-doped ceria), GDC (gadolinium-doped ceria), or SDC (samarium-doped ceria); YSZ (yttria-stabilized zirconia, ZrO₂/Y₂O₃); ScSZ (scandia-stabilized zirconia, ZrO₂/Sc₂O₃); and LSGM (lanthanum gallate doped with strontium and magnesium), or a combination thereof. For example, a solid oxide cell that employs a solid electrolyte layer 300 including an oxygen ion conductor may be an oxygen ion-conducting solid oxide cell.

The solid electrolyte layer 300 may include, as a proton conductor, a proton-conducting metal oxide. The proton-conducting metal oxide may include one or more selected from the group consisting of barium zirconate (BaZrO₃), barium cerate (BaCeO₃), barium zirconate cerate (BaZr₁₋ₓCeₓO₃, 0.05≤x≤0.95), strontium cerate (SrCeO₃), strontium zirconate (SrZrO₃), and strontium zirconate cerate (SrZr₁₋ₓCeₓO₃, 0.05≤x≤0.95) doped with a trivalent element. The trivalent element doped in a proton conductor may include, for example, yttrium (Y), a lanthanide element, or a combination thereof. The lanthanide element may be, for example, ytterbium (Yb). The proton conductor may include, for example, yttrium (Y)-doped barium zirconate, barium zirconate cerate doped with yttrium (Y) and ytterbium (Yb), or a combination thereof. The proton conductor may be, for example, BaZr₁₋ₓYₓO_{3-δ} (0.1≤x≤0.2, 2≤δ<3), BaZr_{0.1}Ce_{0.7}Y_{0.1}Yb_{0.1}O_{2.95}, or the like. For example, a solid oxide cell that employs a solid electrolyte layer 300 including a proton conductor may be a proton-conducting solid oxide cell.

For example, a solid oxide cell that employs a solid electrolyte layer 300 including a mixture of an oxygen ion conductor and a proton conductor may be a mixed-conducting solid oxide cell.

The fuel electrode 200 may provide diffusion of fuel and conduction of electrons. The fuel may include, for example, hydrogen, water vapor (or steam), carbon dioxide, or the like. The fuel electrode 200 may include a fuel electrode current collector 210 and a fuel electrode catalyst layer 220 disposed on the fuel electrode current collector 210. The fuel electrode current collector 210 may be selected from a metal mesh, a metal foam, a metal powder assembly, or a porous carbon structure that are used for the air electrode current collector 110. The material of the fuel electrode current collector 210 may be selected from the materials used as the air electrode current collector 110.

For example, the fuel electrode catalyst layer 220 may include the aforementioned composite conductor.

Alternatively, the fuel electrode catalyst layer 220 may include a solid ion conductor that is distinct from the aforementioned composite conductor. Such a solid ion conductor may, for example, include an oxygen ion conductor, a proton conductor, or a mixture thereof. An oxygen-ion conductor, a proton conductor, or a mixture thereof additionally included in the fuel electrode catalyst layer 220 may be selected from the oxygen-ion conductors, proton conductors, or mixtures thereof used in the solid electrolyte layer 300.

The fuel electrode catalyst layer 220 may further include, for example, a catalyst metal. The catalyst metal may enhance the electronic conductivity of the fuel electrode catalyst layer 220 and may also promote the generation of protons and electrons from fuel or the synthesis of fuel from protons and electrons. The catalyst metal may be, for example, a transition metal. The catalyst metal may be, for example, Ni, Cu, Pt, Pd, or a combination thereof.

The fuel electrode catalyst layer 220 may further include, for example, a carbonaceous material.

The fuel electrode catalyst layer 220 may be prepared, for example, by mixing a catalyst metal oxide, a solid ion conductor, and optionally, a carbonaceous material precursor, followed by sintering. The catalyst metal oxide may exist within the fuel electrode catalyst layer 220 in a reduced state, e.g., as a catalyst metal by hydrogen that is supplied before the operation of the solid oxide cell.

For example, the solid oxide cell 1000 may operate at about 500° C. to about 1100° C., about 500° C. to about 900° C., or about 500° C. to about 750° C. At these operating temperatures, the solid electrolyte layer 300 may provide sufficiently high oxygen-ion conductivity and/or proton conductivity.

Referring to FIG. 3, the solid oxide cell 1000 may further include a barrier layer 400 of layer 400a, and layer 400b (or reaction barrier layer) between the solid electrolyte layer 300 and the air electrode 100 and/or between the solid electrolyte layer 300 and the fuel electrode 200.

For example, the barrier layers 400a and 400b can prevent side reactions between the solid electrolyte layer 300 and the air electrode 100 and/or the fuel electrode 200, thereby improving the durability of the solid oxide cell 1000.

The barrier layers 400a and 400b may include a solid ion conductor. The solid ion conductor used in the barrier layers 400a and 400b may be selected from among the oxygen ion conductor, the proton conductor, or a mixture thereof used in the solid electrolyte layer 300. The solid ion conductor used in the barrier layers 400a and 400b may have a composition that is distinct from the solid ion conductor used in the solid electrolyte layer 300. Therefore, the barrier layers 400a and 400b can suppress side reactions between the solid ion conductor of the solid electrolyte layer 300 and the air electrode 100, thereby improving the durability of the solid oxide cell 1000.

The barrier layer 400a adjacent to the fuel electrode 200 may be omitted.

For example, the solid oxide cell 1000 may operate in a fuel-cell mode in which electricity is produced by supplying fuel to the fuel electrode 200 and supplying air to the air electrode 100.

For example, the solid oxide cell 1000 may operate in an electrolysis-cell mode in which fuel is produced at the fuel electrode 200 by applying an electric field between the fuel electrode 200 and the air electrode 100. For example, the electrolysis-cell mode may be referred to as a hydrogen generation mode or alternatively as a water splitting mode.

An oxygen-ion-conductive solid oxide cell may operate in dual modes (fuel-cell mode and electrolysis-cell mode) according to the reaction equations given below.

### Fuel-Cell Mode

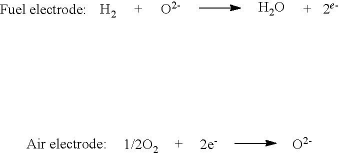

(oxygen reduction reaction, ORR)

### Electrolysis-Cell Mode

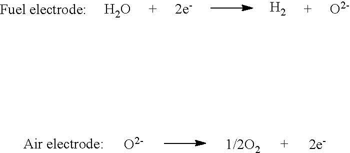

(oxygen evolution reaction, OER)

A proton-conductive solid oxide cell may operate in dual modes (fuel-cell mode and electrolysis-cell mode) according to the reaction equations given below.

### Fuel-Cell Mode

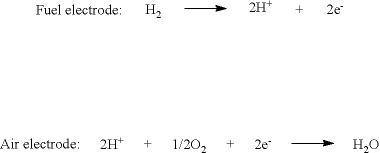

(oxygen reduction reaction, ORR)

### Electrolysis-Cell Mode

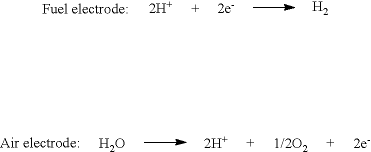

(oxygen evolution reaction, OER)

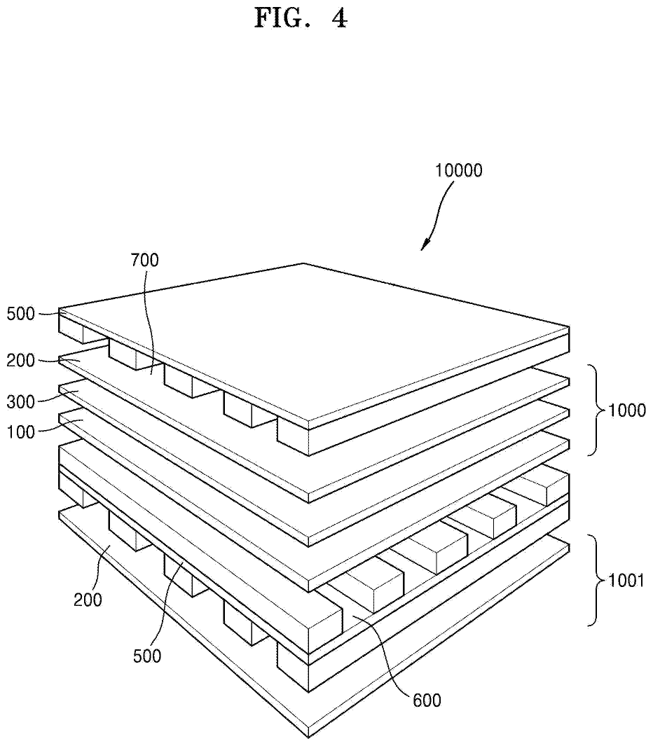

FIG. 4 is a schematic diagram of a solid oxide cell stack 10000 according to an embodiment.

Referring to FIG. 4, the solid oxide cell stack 10000 includes a plurality of solid oxide cells 1000 and 1001 stacked in the thickness direction. Each solid oxide cell 1000 or 1001 may include an air electrode 100, a fuel electrode 200, and a solid electrolyte layer 300 therebetween. The plurality of solid oxide cells 1000 and 1001 may be stacked in the thickness direction, and an interconnect 500 may be disposed between adjacent solid oxide cells 1000 and 1001. The interconnect 500 may include an air passage 600 adjacent to the air electrode 100, and a fuel passage 700 adjacent to the fuel electrode 200. Through the air passage 600, a fluid such as air or oxygen may be supplied to or discharged from the air electrode 100. Through the fuel passage 700, a fuel fluid such as hydrogen, water vapor, or carbon dioxide may be supplied to the fuel electrode 200, or a fluid such as hydrogen or carbon monoxide may be discharged.

The interconnect 500 may be an electrically conductive body. The interconnect 500 may include, for example, a metal. The interconnect 500 may have oxidation resistance, for example, to fluids supplied to the air electrode 100 and the fuel electrode 200 under the operating temperature of the solid oxide cell 1000. The interconnect 500 may have a thermal expansion coefficient (TEC) that is similar to or the same as the TEC of the ceramic components included in the solid electrolyte layer 300 of the solid oxide cells 1000 and 1001. As the interconnect 500, a ferrite alloy steel capable of forming a chromium oxide surface layer may be used, for example.

A method of preparing a solid oxide cell according to another embodiment may include: providing a composition including a first metal oxide having a perovskite structure and a second metal oxide having a perovskite structure; applying the composition on a surface of a first stack including a fuel electrode and a solid electrolyte layer, the surface with the applied composition being adjacent to the solid electrolyte layer to provide a second stack; and heat-treating the second stack to provide the solid oxide cell, the solid oxide cell having an air electrode including a composite conductor.

The composite conductor may include a first mixed conductor including the first metal oxide and a second mixed conductor including the second metal oxide, the ionic conductivity of the first mixed conductor may be greater than the ionic conductivity of the second mixed conductor, and the electronic conductivity of the second mixed conductor may be greater than the electronic conductivity of the first mixed conductor. By such a method of preparing a solid oxide cell, a solid oxide cell that provides improved structural stability and improved conversion efficiency may be manufactured simply and easily.

First, a composition including a first metal oxide having a perovskite structure and a second metal oxide having a perovskite structure is prepared. For example, the composition may be a metal oxide paste including the first metal oxide, the second metal oxide, and a solvent. For example, the solvent may include terpineol and the like, but is not limited thereto. For example, the composition may further include a binder and a conductive agent. For specific details regarding the binder and the conductive agent, refer to the aforementioned air electrode. In the metal oxide paste, the solids content on a dry basis may be, for example, about 0.1 wt % to about 80 wt %, about 0.1 wt % to about 50 wt %, or about 0.1 wt % to about 30 wt %.

For example, the first metal oxide, and the second metal oxide, may independently have a particle form. For example, the particle form may include spherical particles, ellipsoidal particles, polyhedral particles, acicular particles, plate-like particles, rod-like particles, amorphous particles, or a combination thereof. The particle form may be selected according to the structure and/or physical properties of the air electrode or the fuel electrode.

Because the first metal oxide and the second metal oxide have a particle form, pores may be formed between the first metal oxide and the second metal oxide. Therefore, an electrode prepared using a metal oxide paste including the first metal oxide and the second metal oxide may have a porous structure.

For example, the particle size of the first metal oxide may be greater than the particle size of the second metal oxide. For example, the particle size of the first metal oxide and/or the particle size of the second metal oxide may be the average particle size of particles read automatically by software or read by manual inspection from a scanning electron microscope image measured for the first metal oxide powder and/or the second metal oxide powder. For example, the average particle size may be the arithmetic mean particle size. Alternatively, the particle size of the first metal oxide and/or the second metal oxide may be, for example, the D50 particle size. For example, the D50 particle size of the first metal oxide and/or the second metal oxide may be measured by a laser diffraction method.

For example, the ratio MOPD2/MOPD1 of the particle size of the second metal oxide (MOPD2) to the particle size of the first metal oxide (MOPD1) may be 0.95 or less, 0.90 or less, or 0.8 or less. For example, the ratio MOPD2/MOPD1 of the particle size of the second metal oxide (MOPD2) to the particle size of the first metal oxide (MOPD1) may be about 0.5 to about 0.95, about 0.5 to about 0.9, about 0.5 to about 0.8, or about 0.6 to about 0.8. Because the ratio MOPD2/MOPD1 of the particle size of the second metal oxide (MOPD2) to the particle size of the first metal oxide (MOPD1) is in the aforementioned range, the first metal oxide and the second metal oxide may be more effectively packed within the electrode. Because the electrode has an increased packing density, an increased triple phase boundary (TPB) may be formed within the electrode. Because the electrode includes an increased TPB, the number of reaction sites for the electrode reaction is increased, and thereby the electrode may provide improved output or improved energy conversion efficiency.

Alternatively, for example, the ratio MOPD1/MOPD2 of the particle size of the first metal oxide (MOPD1) to the particle size of the second metal oxide (MOPD2) may be 0.95 or less, 0.90 or less, or 0.8 or less. For example, the ratio MOPD1/MOPD2 of the particle size of the first metal oxide (MOPD1) to the particle size of the second metal oxide (MOPD2) may be about 0.5 to about 0.95, about 0.5 to about 0.9, about 0.5 to about 0.8, or about 0.6 to about 0.8. Because the ratio MOPD1/MOPD2 of the particle size of the first metal oxide (MOPD1) to the particle size of the second metal oxide (MOPD2) is in the aforementioned range, the second metal oxide and the first metal oxide may be more effectively packed within the electrode. Because the electrode has an increased packing density, an increased triple phase boundary (TPB) may be formed within the electrode. Because the electrode includes an increased TPB, the number of reaction sites for the electrode reaction is increased, and thereby the electrode may provide improved output or improved energy conversion efficiency.

For example, the particle size of the first metal oxide may be 4 μm or less, 3 μm or less, 2 μm or less, 1.5 μm or less, or 1 μm or less. For example, the particle size of the first metal oxide may be about 0.1 μm to about 4 μm, about 0.1 μm to about 3 μm, about 0.1 μm to about 2 μm, about 0.1 μm to about 1.5 μm, or about 0.1 μm to about 1 μm. Because the first metal oxide has a particle size in the aforementioned range, an electrode manufactured using a metal oxide paste including the first metal oxide may provide further improved energy conversion efficiency.

For example, the particle size of the second metal oxide may be 2 μm or less, 1.5 μm or less, or 1 μm or less. For example, the particle size of the second metal oxide may be about 0.1 μm to about 2 μm, about 0.1 μm to about 1.5 μm, or about 0.1 μm to about 1 μm. Because the second metal oxide has a particle size in the aforementioned range, an electrode manufactured using a metal oxide paste including the second metal oxide may provide further improved energy conversion efficiency.

For example, the particle size of the first metal oxide may be 4 μm or less, and the particle size of the second metal oxide may be 2 μm or less. For example, the particle size of the first metal oxide may be 3 μm or less, and the particle size of the second metal oxide may be 2 μm or less. For example, the particle size of the first metal oxide may be 2 μm or less, and the particle size of the second metal oxide may be 2 μm or less. For example, the particle size of the first metal oxide may be 2 μm or less, and the particle size of the second metal oxide may be 1.5 μm or less. For example, the particle size of the first metal oxide may be 2 μm or less, and the particle size of the second metal oxide may be 1 μm or less. For example, the particle size of the first metal oxide may be 1.5 μm or less, and the particle size of the second metal oxide may be 1.5 μm or less. For example, the particle size of the first metal oxide may be 1 μm or less, and the particle size of the second metal oxide may be 1 μm or less. Because the first metal oxide and the second metal oxide have particle sizes in these ranges, the triple phase boundary (TPB) formed within an electrode manufactured using a metal oxide paste including the first and second metal oxides may be increased. Consequently, an electrode including the increased TPB may provide further improved energy conversion efficiency.

For example, the mixing ratio of the first metal oxide and the second metal oxide, as a weight ratio, may be about 7:3 to about 3:7, about 6.5:3.5 to about 3.5:6.5, about 6:4 to about 4:6, or about 5.5:4.5 to about 4.5:5.5. Because the first metal oxide and the second metal oxide have a mixing ratio in the aforementioned range, an electrode manufactured using a metal oxide paste including the first and second metal oxides may simultaneously provide further improved ionic conductivity and electronic conductivity. Consequently, an electrode including the first and second metal oxides may provide further improved energy conversion efficiency.

Next, a second stack may be prepared by applying the composition on a surface of a first stack including a fuel electrode and a solid electrolyte layer, the surface with the applied composition being adjacent to the solid electrolyte layer.

The second stack is prepared by applying the composition on the solid electrolyte layer of the first stack that includes the fuel electrode and the solid electrolyte layer, or, in a case in which a barrier layer is disposed on the solid electrolyte layer, by applying the composition on the barrier layer. Although the first stack including the fuel electrode and the solid electrolyte layer is used as the substrate on which the composition is applied, the substrate is not limited to such a first stack, and other substrates such as the solid electrolyte layer or the air electrode current collector may be used depending on required conditions. The method of applying the composition is not particularly limited, and screen printing, doctor blade coating, Slot Die coating, dip coating, spin coating, spray coating, and the like may be used. After coating the composition on the first stack, the solvent may be removed by drying. For example, the drying may be performed in a drying oven.

Next, the method includes heat-treating the second stack to provide a solid oxide cell having an air electrode that includes a composite conductor.

For example, the heat treatment of the second stack may be performed at about 800° C. to about 1100° C. for about 1 hour to about 24 hours. For example, the heat treatment may be performed in an oxidizing atmosphere. For example, the oxidizing atmosphere may include oxygen. By this heat treatment, the first metal oxide and the second metal oxide may form a composite, e.g, a composite at an interface of the two metal oxides, and a solid oxide cell having an air electrode including a composite conductor containing the first mixed conductor and the second mixed conductor may be prepared. The composite conductor includes the first mixed conductor including the first metal oxide and the second mixed conductor including the second metal oxide, the ionic conductivity of the first mixed conductor is greater than the ionic conductivity of the second mixed conductor, and the electronic conductivity of the second mixed conductor is greater than the electronic conductivity of the first mixed conductor. By such a method for manufacturing a solid oxide cell, a solid oxide cell that provides improved structural stability and improved conversion efficiency may be manufactured simply and easily.

Hereinafter, the present disclosure will be described in further detail with reference to Examples and Comparative Examples; however, the scope of the disclosure is not limited to these examples.

### Preparation of First Mixed Conductor Powder

### Preparation Example 1: Ba_{0.5}Sr_{0.5}Co_{0.8}Fe_{0.1}Zn_{0.1}O_{3-δ} (BSCFZ-1)

A mixed powder was prepared by mixing SrCO₃ as a first-1 element precursor, BaCO₃ as a first-2 element precursor, Co₃O₄ as a first-3 element precursor, Fe₂O₃ as a first-4 element precursor, and ZnO as a first-5 element precursor in a stoichiometric ratio. The mixed powder was subjected to calcination in a furnace at 1000° C. for 2 hours to prepare a first mixed conductor in powder form having the composition disclosed in Table 1 below. The composition of the prepared first mixed conductor was Ba_{0.5}Sr_{0.5}Co_{0.8}Fe_{0.1}Zn_{0.1}O_{3-δ} (0≤δ<1) (BSCFZ-1). The average particle size of the first mixed conductor was 3.66 μm. For the average particle size of the first mixed conductor, an arithmetic mean value calculated using software from a scanning electron microscope image of the first mixed conductor powder was used.

### Preparation Example 1A: Ba_{0.5}Sr_{0.5}Co_{0.8}Fe_{0.1}Zn_{0.1}O_{3-δ} (BSCFZ-3)

A milled Ba_{0.5}Sr_{0.5}Co_{0.8}Fe_{0.1}Zn_{0.1}O_{3-δ} (0≤δ<1) (BSCFZ-3) powder having an average particle size of 0.48 μm to 1.39 μm was prepared by subjecting the Ba_{0.5}Sr_{0.5}Co_{0.8}Fe_{0.1}Zn_{0.1}O_{3-δ} (0≤δ<1) (BSCFZ-1) powder having an average particle size of 3.66 μm prepared in Preparation Example 1 to planetary milling. For the average particle size of the prepared first mixed conductor, an arithmetic mean value calculated using software from a scanning electron microscope image of the first mixed conductor powder was used.

### Preparation Example 2: Ba_{0.5}Sr_{0.5}Co_{0.8}Fe_{0.1}Zn_{0.1}O_{3-δ} (BSCFZ-2)

A commercially available Ba_{0.5}Sr_{0.5}Co_{0.8}Fe_{0.1}Zn_{0.1}O_{3-δ} (0≤δ<1) (BSCFZ-2) powder (from Kceracell) having an average particle size of 1.09 μm was used as is. For the average particle size of the prepared first mixed conductor, an arithmetic mean value calculated using software from a scanning electron microscope image of the first mixed conductor powder was used.

### Preparation of Second Mixed Conductor Powder

### Preparation Example 3: La_{0.6}Sr_{0.4}Co_{0.2}Fe_{0.8}O_{3-δ} (LSCF-1)

A mixed powder was prepared by mixing La₂O₃ as a second-1 element precursor, SrCO₃ as a second-2 element precursor, Co₃O₄ as a second-3 element precursor, and Fe₂O₃ as a second-4 element precursor in a stoichiometric ratio.

The mixed powder was subjected to calcination in a furnace at 1000° C. for 2 hours to prepare a second mixed conductor in powder form having the composition disclosed in Table 1 below. The composition of the prepared second mixed conductor was La_{0.6}Sr_{0.4}Co_{0.2}Fe_{0.8}O_{3-δ} (0≤δ<1) (LSCF-1). The average particle size of the prepared second mixed conductor was 0.68 μm. For the average particle size of the second mixed conductor, an arithmetic mean value calculated using software from a scanning electron microscope image of the second mixed conductor powder was used.

### Preparation Example 4: La_{0.6}Sr_{0.4}Co_{0.2}Fe_{0.8}O_{3-δ} (LSCF-2)

A commercially available La_{0.6}Sr_{0.4}Co_{0.2}Fe_{0.8}O_{3-δ} (0≤δ<1) (LSCF-2) powder (from FCM) having an average particle size of 0.4 μm to 0.8 μm was used as is. The average particle size of the prepared second mixed conductor is the D50 particle size.

### Preparation Example 5: La_{0.6}Sr_{0.4}CoO_{3-δ} (LSC)

A commercially available La_{0.6}Sr_{0.4}CoO_{3-δ} (0≤δ<1) (LSC) powder having an average particle size of 0.84 μm was used as is. For the average particle size of the prepared second mixed conductor, an arithmetic mean value calculated using software from a scanning electron microscope image of the second mixed conductor powder was used.

### Evaluation Example 1: Evaluation of Electronic Conductivity and Ionic Conductivity

The known ionic conductivities and electronic conductivities for Ba_{0.5}Sr_{0.5}Co_{0.8}Fe_{0.1}Zn_{0.1}O_{3-δ} (BSCFZ), Ba_{0.5}Sr_{0.5}Co_{0.8}Fe_{0.2}O_{3-δ} (BSCF), La_{0.6}Sr_{0.4}Co_{0.2}Fe_{0.8}O_{3-δ} (LSCF), and La_{0.6}Sr_{0.4}CoO_{3-δ} (LSC) are shown in Table 1 below.

TABLE 1

| | | Ionic | Electronic |
|---|---|---|---|
| | | Conductivity | Conductivity |
| | | (σᵢ) | (σₑ) |
| | Composition | [S/cm] | [S/cm] |
| First | Ba_{0.5}Sr_{0.5}Co_{0.8}Fe_{0.1}Zn_{0.1}O_{3-δ} | 0.53 | 31 |
| Mixed | (BSCFZ) | (700° C.) | (700° C.) |
| Conductor | | | |
| First | Ba_{0.5}Sr_{0.5}Co_{0.8}Fe_{0.2}O_{3-δ} | 0.53 | 35 |
| Mixed | (BSCF) | (700° C.) | (700° C.) |
| Conductor | | | |
| Second | La_{0.6}Sr_{0.4}Co_{0.2}Fe_{0.8}O_{3-δ} | 0.01 | 275 |
| Mixed | (LSCF) | (700° C.) | (700° C.) |
| Conductor | | | |
| Second | La_{0.6}Sr_{0.4}CoO_{3-δ} | 0.22 | 1585 |
| Mixed | (LSC) | (800° C.) | (800° C.) |
| Conductor | | | |

As shown in Table 1, the first mixed conductors, BSCFZ and BSCF, have a relatively high ionic conductivity compared to the second mixed conductors, LSCF and LSC.

The second mixed conductors, LSCF and LSC, have a relatively high electronic conductivity and a relatively low ionic conductivity compared to the first mixed conductors, BSCFZ and BSCF.

Therefore, the first mixed conductor has a higher ionic conductivity and a lower electronic conductivity compared to the second mixed conductor. In addition, the second mixed conductor has a higher electronic conductivity and a lower ionic conductivity compared to the first mixed conductor.

### Evaluation Example 2: Evaluation of Thermal Expansion Coefficient

The known thermal expansion coefficients for Ba_{0.5}Sr_{0.5}Co_{0.8}Fe_{0.1}Zn_{0.1}O_{3-δ} (BSCFZ), Ba_{0.5}Sr_{0.5}Co_{0.8}Fe_{0.2}O_{3-δ} (BSCF), La_{0.6}Sr_{0.4}Co_{0.2}Fe_{0.8}O_{3-δ} (LSCF), and La_{0.6}Sr_{0.4}CoO_{3-δ} (LSC) are shown in Table 2 below.

TABLE 2

| | | Thermal Expansion |
|---|---|---|
| | Composition | Coefficient [10⁻⁶/K] |
| First Mixed | Ba_{0.5}Sr_{0.5}Co_{0.8}Fe_{0.1}Zn_{0.1}O_{3-δ} | 17.1 |
| Conductor | (BSCFZ) | |
| First Mixed | Ba_{0.5}Sr_{0.5}Co_{0.8}Fe_{0.2}O_{3-δ} | 19.7 |
| Conductor | (BSCF) | |
| Second Mixed | La_{0.6}Sr_{0.4}Co_{0.2}Fe_{0.8}O_{3-δ} | 17.5 |
| Conductor | (LSCF) | |
| Second Mixed | La_{0.6}Sr_{0.4}CoO_{3-δ} | 20.5 |
| Conductor | (LSC) | |

As shown in Table 2, the first mixed conductor and the second mixed conductor exhibited a thermal expansion coefficient of 17 to 21. In contrast, the thermal expansion coefficient of GDC, which is the material of the barrier layer used in Examples 1 to 5, is about 12.8.

### Preparation of Electrode and Solid Oxide Cell)

### Example 1: Air Electrode with BSCFZ-1 (3.66 μm)+LSCF-1 (0.68 μm)

A half-cell obtained from Elcogen was prepared as a first stack.

The Elcogen half-cell had a structure including a fuel electrode support (Ni+YSZ layer)/a fuel electrode functional layer (Ni+YSZ layer, 12 μm)/an electrolyte layer (YSZ layer, 5.4 μm)/a barrier layer (GDC layer, 1.7 μm). As mentioned hereinabove, YSZ indicates yttria-stabilized zirconia, and GDC indicates gadolinium-doped ceria.

A mixed conductor paste was prepared by mixing at a weight ratio of 2:1, an ink vehicle solution (from FCM) with a powder mixture, the powder mixture being a 1:1 weight ratio mixture of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1 and the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

A second stack was prepared by coating the mixed conductor paste on the barrier layer of the Elcogen half-cell by a screen printing method and sintering the coated paste in an air atmosphere at 950° C. for 2 hours. The second stack had a structure of a fuel electrode support (Ni+YSZ layer)/a fuel electrode functional layer (Ni+YSZ layer, 12 μm)/an electrolyte layer (YSZ layer, 5.4 μm)/a barrier layer (GDC layer, 1.7 μm)/an air electrode (BSCFZ-1+LSCF-1, 11.5 μm). A solid oxide cell was prepared by disposing a Pt mesh and a CuMn foam on the air electrode of the second stack and connecting wires.

### Example 2: Air Electrode with BSCFZ-2 (1.09 μm)+LSCF-1 (0.68 μm)

The air electrode and the solid oxide cell were prepared in the same manner as in Example 1, except that the commercially available Ba_{0.5}Sr_{0.5}Co_{0.8}Fe_{0.1}Zn_{0.1}O_{3-δ} (BSCFZ-2) powder (from Kceracell) having an average particle size of 1.09 μm prepared in Preparation Example 2 was used instead of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1.

### Example 3: Air Electrode with BSCFZ-3 (0.48 μm to 1.39 μm)+LSCF-1 (0.68 μm)

The air electrode and the solid oxide cell were prepared in the same manner as in Example 1, except that the Sr_{0.5}Ba_{0.5}Co_{0.8}Fe_{0.1}Zn_{0.1}O_{3-δ} (BSCFZ-3) powder having an average particle size of 0.48 μm to 1.39 μm prepared in Preparation Example 1A was used instead of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1.

### Example 4: Air Electrode with BSCFZ-2 (1.09 μm)+LSCF-2 (0.4 μm to 0.8 μm)

The air electrode and the solid oxide cell were prepared in the same manner as in Example 1, except that the commercially available Ba_{0.5}Sr_{0.5}Co_{0.8}Fe_{0.1}Zn_{0.1}O_{3-δ} (BSCFZ-2) powder (from Kceracell) having an average particle size of 1.09 μm prepared in Preparation Example 2 was used instead of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the commercially available La_{0.6}Sr_{0.4}Co_{0.2}Fe_{0.803}-6 (LSCF-2) powder (from FCM) having an average particle size of 0.4 μm to 0.8 μm prepared in Preparation Example 4 was used instead of the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Example 5: Air Electrode with BSCFZ-2 (1.09 μm)+LSC

The air electrode and the solid oxide cell were prepared in the same manner as in Example 1, except that the commercially available Ba_{0.5}Sr_{0.5}Co_{0.8}Fe_{0.1}Zn_{0.1}O_{3-δ} (BSCFZ-2) powder (from Kceracell) having an average particle size of 1.09 μm prepared in Preparation Example 2 was used instead of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the second mixed conductor, La_{0.6}Sr_{0.4}CoO_{3-δ} (LSC) having an average particle size of 0.84 μm, prepared in Preparation Example 5 was used instead of the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Comparative Example 1: LSC Air Electrode

The air electrode and the solid oxide cell were prepared in the same manner as in Example 1, except that the second mixed conductor, the La_{0.6}Sr_{0.4}CoO_{3-δ} (LSC) powder having an average particle size of 0.84 μm prepared in Preparation Example 5, was used alone instead of the 1:1 weight ratio mixed powder of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Comparative Example 2: Air Electrode with BSCFZ-1 (3.66 μm)

The air electrode and the solid oxide cell were prepared in the same manner as in Example 1, except that the first mixed conductor, the Sr_{0.5}Ba_{0.5}Co_{0.8}Fe_{0.1}Zn_{0.1}O_{3-δ} (BSCFZ-1) powder having an average particle size of 3.66 μm prepared in Preparation Example 1 was used alone instead of the 1:1 weight ratio mixed powder of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Comparative Example 3: Air Electrode with BSCFZ-2 (1.09 μm)

The air electrode and the solid oxide cell were prepared in the same manner as in Example 1, except that the commercially available Ba_{0.5}Sr_{0.5}Co_{0.8}Fe_{0.1}Zn_{0.1}O_{3-δ} (BSCFZ-2) powder (from Kceracell) having an average particle size of 1.09 μm prepared in Preparation Example 2 was used alone instead of the 1:1 weight ratio mixed powder of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Comparative Example 4: Air Electrode with BSCFZ-3 (0.48 μm to 1.39 μm)

The air electrode and the solid oxide cell were prepared in the same manner as in Example 1, except that the Ba_{0.5}Sr_{0.5}Co_{0.8}Fe_{0.1}Zn_{0.1}O_{3-δ} (BSCFZ-3) powder having an average particle size of 0.48 μm to 1.39 μm prepared in Preparation Example 1A was used alone instead of the 1:1 weight ratio mixed powder of the Ba_{0.5}Sr_{0.5}Co_{0.8}Fe_{0.1}Zn_{0.1}O_{3-δ} (BSCFZ-1) powder (the first mixed conductor) having an average particle size of 3.66 μm prepared in Preparation Example 1, and the La_{0.6}Sr_{0.4}Co_{0.2}Fe_{0.8}O_{3-δ} (LSCF-1) powder (the second mixed conductor) having an average particle size of 0.68 μm prepared in Preparation Example 3.

### Evaluation Example 3: X-ray Diffraction Analysis (I)

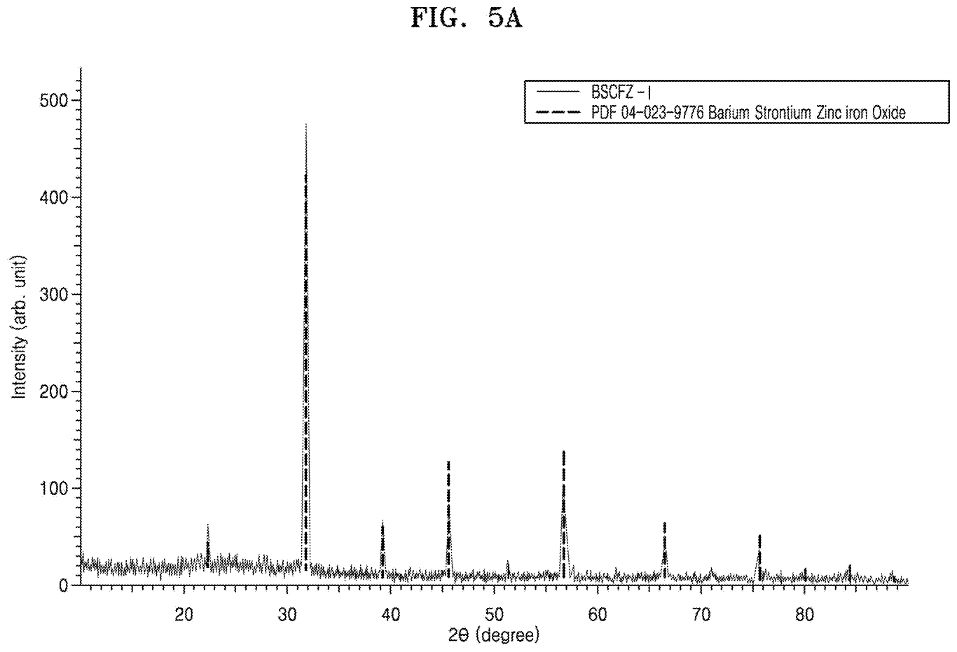

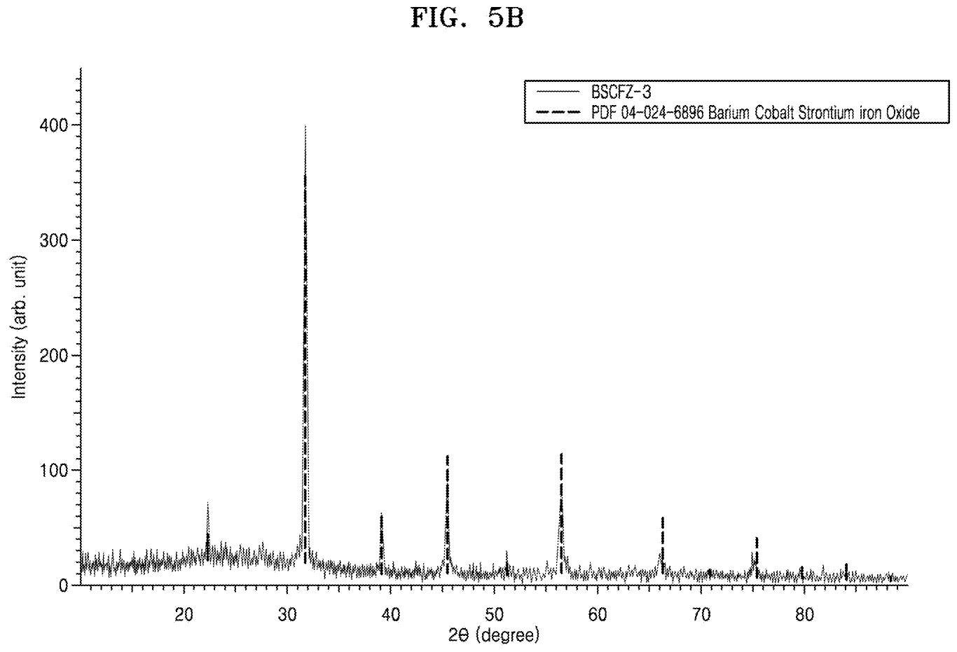

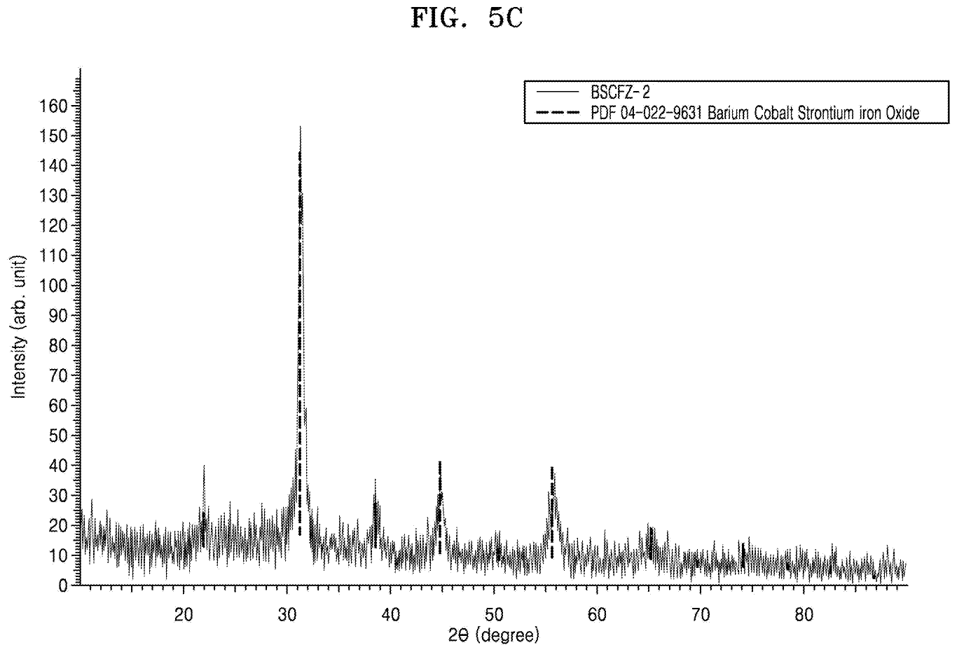

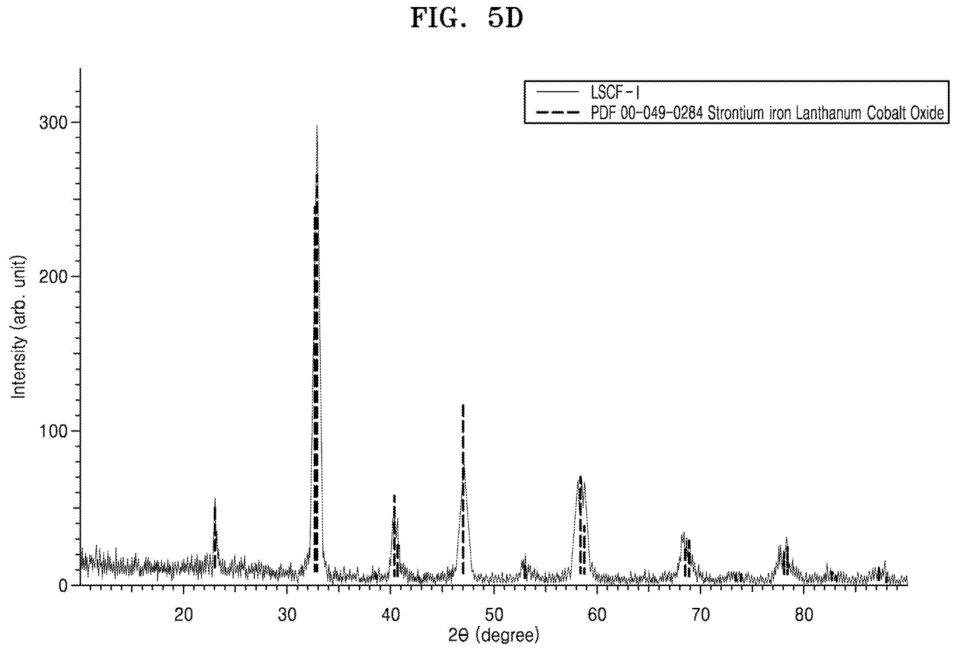

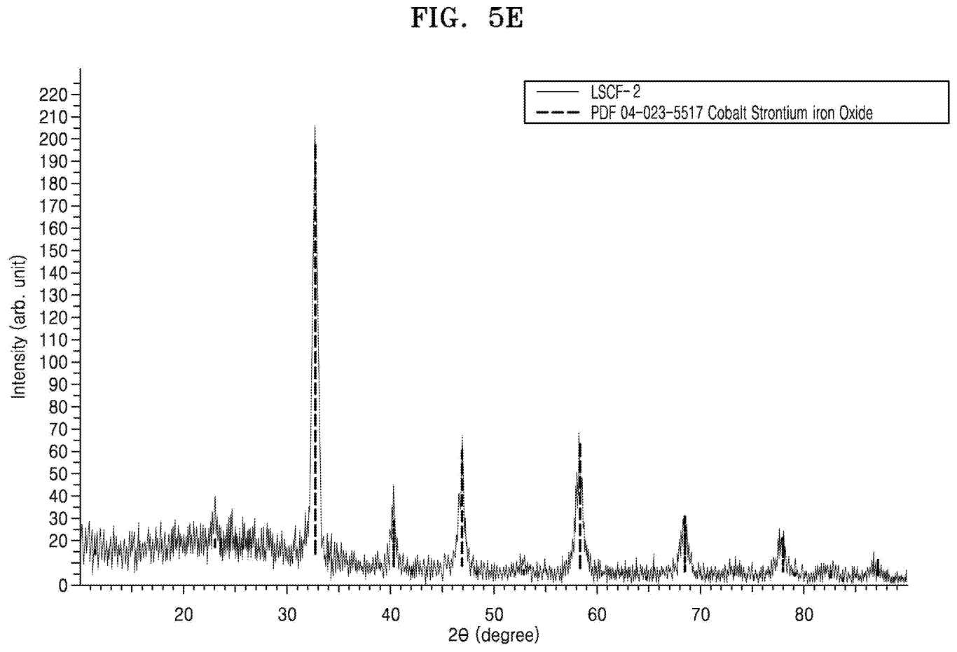

An XRD spectrum was measured for the first mixed conductor, the Ba_{0.5}Sr_{0.5}Co_{0.8}Fe_{0.1}Zn_{0.103}-8 (BSCFZ-1) powder prepared in Preparation Example 1, and for the milled first mixed conductor, the Ba_{0.5}Sr_{0.5}Co_{0.8}Fe_{0.1}Zn_{0.1}O_{3-δ} (BSCFZ-3) powder prepared in Preparation Example 1A, and a portion of the results is shown in FIGS. 5A and 5B, respectively.

The XRD spectrum was measured using a D8 Advance (Bruker, Germany) with Cu Kα radiation (1.54056 Å). As shown in FIGS. 5A and 5B, it was confirmed that the mixed conductors prepared in Preparation Example 1 and Preparation Example 1A exhibited characteristic peaks corresponding to a perovskite structure and thus had the same crystal structure as each other. Moreover, because FIG. 5B did not show any new peaks compared to FIG. 5A, it was confirmed that no new secondary phase was formed by the milling.

An XRD spectrum was measured for the commercially available Ba_{0.5}Sr_{0.5}Co_{0.8}Fe_{0.1}Zn_{0.1}O_{3-δ} (BSCFZ-2) powder having an average particle size of 1.09 μm prepared in Preparation Example 2, the La_{0.6}Sr_{0.4}Co_{0.2}Fe_{0.8}O_{3-δ} (LSCF-1) powder (the second mixed conductor) having an average particle size of 0.68 μm prepared in Preparation Example 3, and the commercially available La_{0.6}Sr_{0.4}Co_{0.2}Fe_{0.8}O₃ (LSCF-2) powder having an average particle size of 0.4 μm to 0.8 μm prepared in Preparation Example 4, and the results are shown in FIGS. 5C to 5E.

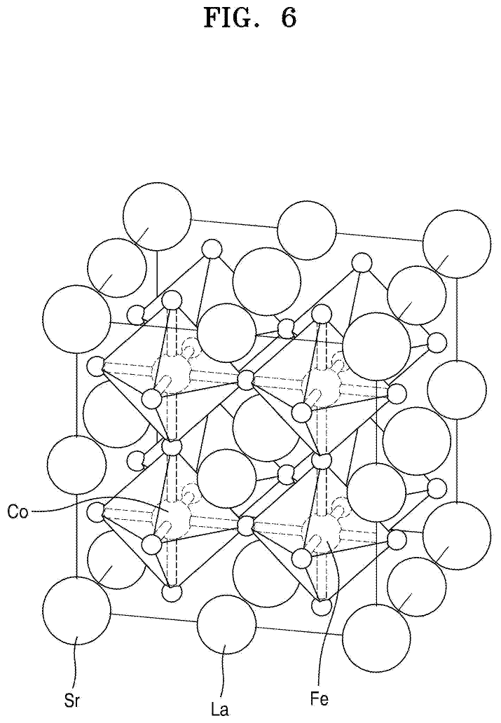

Referring to FIG. 6, in the solid ion conductors having a perovskite structure from Preparation Examples 1 to 5, Ba, La, and/or Sr occupy the 12-coordinated cuboctahedral sites, while Co, Fe, and/or Zn occupy the 6-coordinated octahedral sites.

### Evaluation Example 4: X-ray Diffraction Analysis (II)

An XRD spectrum was measured for the Ba_{0.5}Sr_{0.5}Co_{0.8}Fe_{0.1}Zn_{0.1}O_{3-δ} (BSCFZ-2) powder (the first mixed conductor) prepared in Preparation Example 2; the La_{0.6}Sr_{0.4}Co_{0.2}Fe_{0.8}O_{3-δ} (LSCF-2) powder (the second mixed conductor) prepared in Preparation Example 4; a room-temperature mixture thereof; and a sintered product of the mixture, sintered in an air atmosphere at 950° C. for 2 hours, and a portion of the results is shown in FIG. 7A.

An XRD spectrum was measured for the Ba_{0.5}Sr_{0.5}Co_{0.8}Fe_{0.1}Zn_{0.1}O_{3-δ} (BSCFZ-2) powder (the first mixed conductor) prepared in Preparation Example 2; the La_{0.6}Sr_{0.4}CoO_{3-δ} (LSC) powder (the second mixed conductor) prepared in Preparation Example 5; a room-temperature mixture thereof; and a sintered product of the mixture, sintered in an air atmosphere at 950° C. for 2 hours, and a part of the results thereof is shown in FIG. 7B.

The XRD spectrum was measured using a D8 Advance (Bruker, Germany) with Cu Kα radiation (1.54056 Å). As shown in FIG. 7A, the XRD spectrum of the room-temperature mixture of the Ba_{0.5}Sr_{0.5}Co_{0.8}Fe_{0.1}Zn_{0.1} O_{3-δ} (BSCFZ-2) powder and the La_{0.6}Sr_{0.4}Co_{0.2}Fe_{0.8}O_{3-δ} (LSCF-2) powder was consistent with a simple superposition of the XRD spectra for each thereof. In contrast, in the XRD spectrum of the sintered product of the Ba_{0.5}Sr_{0.5}Co_{0.8}Fe_{0.1}Zn_{0.1}O_{3-δ} (BSCFZ-2) powder and the La_{0.6}Sr_{0.4}Co_{0.2}Fe_{0.8}O_{3-δ} (LSCF-2) powder, sintered in an air atmosphere at 950° C. for 2 hours, the characteristic peak positions for each thereof at 30° to 35° moved closer to each other. This change in peak position confirmed formation of a composite which includes chemical bonds formed due to partial sintering at the interface of the Ba_{0.5}Sr_{0.5}Co_{0.8}Fe_{0.1}Zn_{0.1}O_{3-δ} (BSCFZ-2) powder and the La_{0.6}Sr_{0.4}Co_{0.2}Fe_{0.8}O_{3-δ} (LSCF-2) powder.

As shown in FIG. 7B, the XRD spectrum of the room-temperature mixture of the Ba_{0.5}Sr_{0.5}Co_{0.8}Fe_{0.1}Zn_{0.1}O_{3-δ} (BSCFZ-2) powder and the La_{0.6}Sr_{0.4}CoO_{3-δ} (LSC) powder was consistent with a simple superposition of the XRD spectra of each. In contrast, in the XRD spectrum of the sintered product of the Ba_{0.5}Sr_{0.5}Co_{0.8}Fe_{0.1}Zn_{0.1}O_{3-δ} (BSCFZ-2) powder and the La_{0.6}Sr_{0.4}CoO_{3-δ} (LSC) powder, sintered in an air atmosphere at 950° C. for 2 hours, the characteristic peak positions for each thereof at 30° to 35° are confirmed to move closer to one another. This change in peak position confirmed formation of a composite which includes chemical bonds formed due to partial sintering at the interface of the Ba_{0.5}Sr_{0.5}Co_{0.8}Fe_{0.1}Zn_{0.1}O_{3-δ} (BSCFZ-2) powder and the La_{0.6}Sr_{0.4}CoO_{3-δ} (LSC) powder.

### Evaluation Example 5: Scanning Electron Microscope Analysis

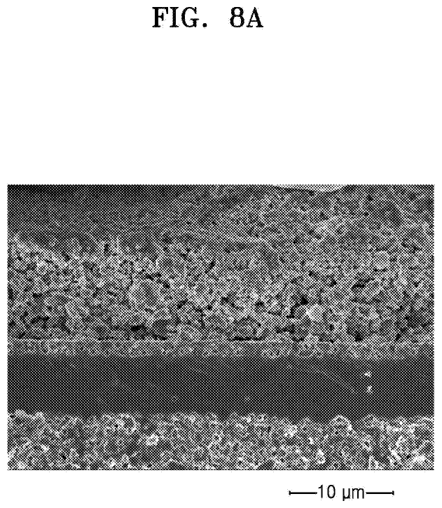

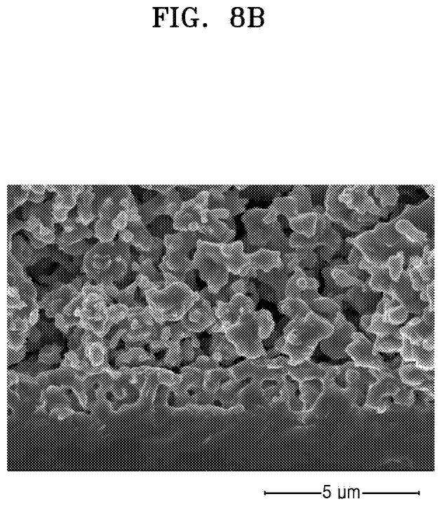

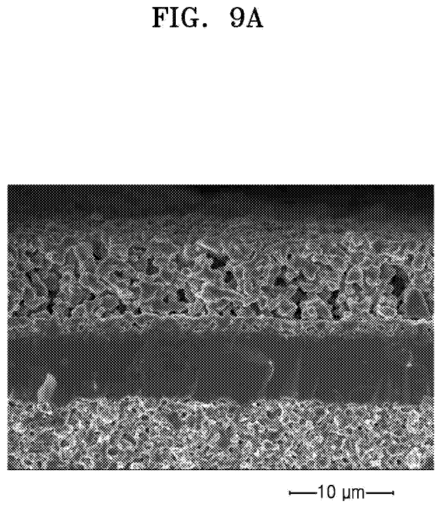

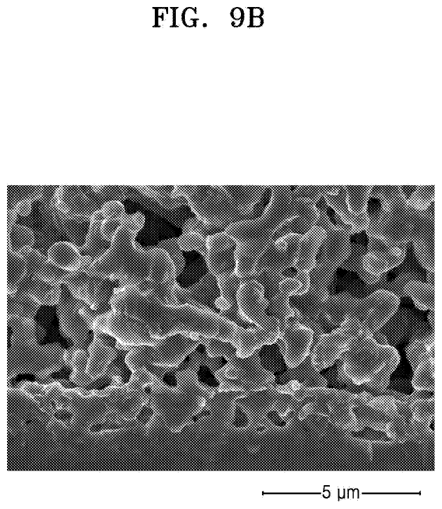

Scanning electron microscope images were obtained of cross-sections of the solid oxide cells prepared in Example 3 and Comparative Example 4, and the measurement results are shown in FIGS. 8A to 9B. FIG. 8A is a scanning electron microscope image of a cross-section of the solid oxide cell prepared in Example 3. FIG. 8B is a partially enlarged view of FIG. 8A. FIG. 9A is a scanning electron microscope image of a cross-section of the solid oxide cell prepared in Comparative Example 4. FIG. 9B is a partially enlarged view of FIG. 9A.

As shown in FIGS. 8A to 9B, it was shown that the air electrode of the solid oxide cell of Example 3 has a more compact structure than the air electrode of the solid oxide cell of Comparative Example 4, due to additionally including the second mixed conductor having a reduced particle size.

### Evaluation Example 6: Durability Evaluation

For the solid oxide cell including the air electrode prepared in Example 4, the change in voltage over time was measured while applying a constant current at a current density of 1.0 amperes per square centimeter (A/cm²) at 700° C. for 100 hours. While applying the constant current, the Hydrogen Evolution Reaction (HER) and the Oxygen Evolution Reaction (OER) proceeded at the fuel electrode and the air electrode, respectively.

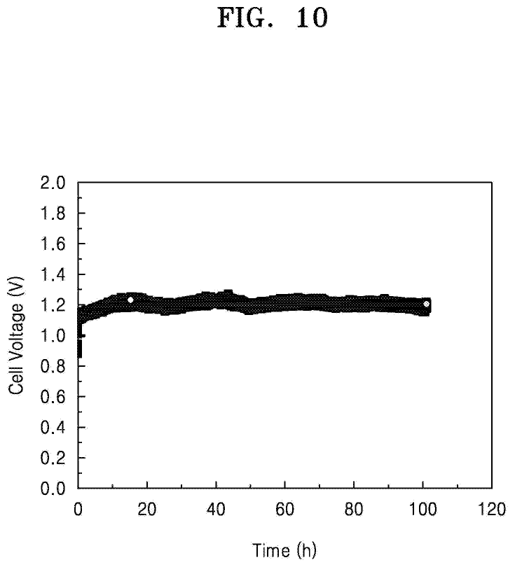

FIG. 10 is a graph illustrating the change in voltage over time for the solid oxide cell of Example 4.

In the solid oxide cell of Example 4, the voltage of the solid oxide cell was stable while the constant current was applied for 100 hours. It was confirmed that the structural stability and lifetime characteristics of the solid oxide cell of Example 4 were improved.

### Evaluation Example 7: Evaluation of Solid Oxide Cell Performance

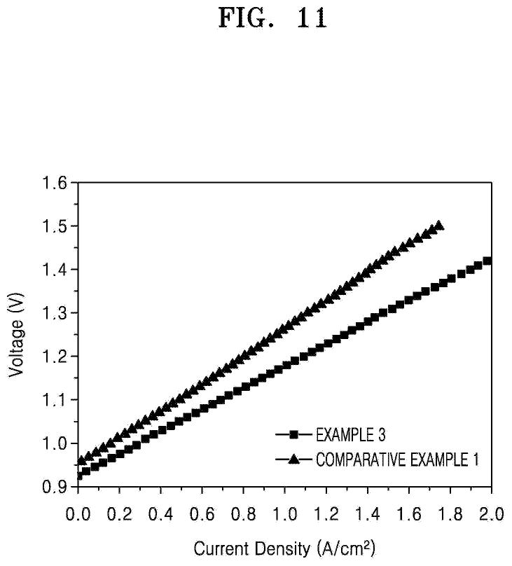

The performance of the solid oxide cells prepared in Examples 1 to 5 and Comparative Examples 1 to 3 was evaluated at 700° C. A part of the evaluation results is shown in Table 3 below and in FIG. 11.

FIG. 11 is a graph illustrating the current density versus voltage for the solid oxide cells prepared in Example 3 and Comparative Example 1.

In EC (Electrolysis Cell) mode, the current was measured while varying the voltage. In EC mode, air was supplied to the air electrode at a flow rate of 200 sccm, and H₂O/H₂ (80 v % H₂O, 20 v % H₂) was supplied to the fuel electrode at a flow rate of 200 sccm. The initial performance evaluation results in EC mode are shown in Table 3.

TABLE 3

| | | Current Density |
|---|---|---|
| | | at 1.3 V [A/cm², |
| | Air Electrode Composition | 700° C.] |
| Example 1 | BSCFZ-1 (3.66 μm) + | 0.820 |
| | LSCF-1 (0.68 μm) | |
| Example 2 | BSCFZ-2 (1.09 μm) + | 1.079 |
| | LSCF-1 (0.68 μm) | |
| Example 3 | BSCFZ-3 (0.48 μm to 1.39 μm) + | 1.475 |
| | LSCF-1 (0.68 μm) | |
| Example 4 | BSCFZ-2 (1.09 μm) + | 1.122 |
| | LSCF-2 (0.4 μm to 0.8 μm) | |
| Example 5 | BSCFZ-2 (1.09 μm) + | 1.075 |
| | LSC (0.84 μm) | |
| Comparative | LSC (0.84 μm) | 1.11 |
| Example 1 | | |
| Comparative | BSCFZ-1 (3.66 μm) | 0.664 |
| Example 2 | | |
| Comparative | BSCFZ-2 (1.09 μm) | 0.759 |
| Example 3 | | |

As shown in Table 3, the solid oxide cells of Examples 1 to 5 exhibited an improved current density at the thermal neutral voltage (1.3 V) compared to the solid oxide cells of Comparative Examples 2 and 3. The solid oxide cells of Examples 2 to 5 exhibited a similar or improved current density compared to the solid oxide cell of Comparative Example 1. The solid oxide cells of Examples 3 to 4 showed that the efficiency of the electrolysis reaction was increased, and thus the amount of hydrogen and oxygen produced was further increased, compared to the solid oxide cells of Examples 1, 2, and 5.

Although not shown in Table 3, the solid oxide cells of Examples 1 to 5 had good lifetime characteristics during long-term operation because the difference in the thermal expansion coefficient with the barrier layer was reduced.

As shown in Table 3, the LSC air electrode of Comparative Example 1 exhibited a good current density. However, although not shown in Table 3, its lifetime characteristics were poor due to the problem of air electrode delamination during long-term operation caused by a relative increase in the thermal expansion coefficient difference with the barrier layer.

Various modifications may be made within the scope of the appended claims, the detailed description, and the accompanying drawings, and such modifications should be understood to be encompassed within the scope of the present disclosure.

According to an aspect, by including a composite conductor that simultaneously contains a first mixed conductor having high ionic conductivity and a second mixed conductor having high electronic conductivity, a novel electrode having improved structural stability and improved conversion efficiency, and a solid oxide cell including the same, may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electrode comprising
a composite conductor, wherein the composite conductor includes a first mixed conductor comprising a first metal oxide having a perovskite structure, and
a second mixed conductor comprising a second metal oxide having a perovskite structure,
wherein ionic conductivity of the first mixed conductor is greater than ionic conductivity of the second mixed conductor, and
electronic conductivity of the second mixed conductor is greater than electronic conductivity of the first mixed conductor.

2. The electrode of claim 1,
wherein the ionic conductivity of the first mixed conductor is 0.2 Siemens per centimeter or more at 700° C.

3. The electrode of claim 1,
wherein the electronic conductivity of the second mixed conductor is 100 Siemens per centimeter or more at 700° C.

4. The electrode of claim 1,
wherein a thermal expansion coefficient of the first mixed conductor is less than that of the second mixed conductor.

5. The electrode of claim 1,
wherein a thermal expansion coefficient of the first mixed conductor is 20×10⁻⁶/K or less.

6. The electrode of claim 1,
wherein the first mixed conductor and the second mixed conductor have a particulate form, and
a particle size of the first mixed conductor is greater than a particle size of the second mixed conductor.

7. The electrode of claim 6,
wherein a ratio PD2/PD1 of a particle size PD2 of the second mixed conductor to a particle size PD1 of the first mixed conductor is about 0.6 to about 0.8.

8. The electrode of claim 6,
wherein a particle size of the first mixed conductor is 4 micrometers or less, and
a particle size of the second mixed conductor is 2 micrometers or less.

9. The electrode of claim 1,
wherein a ratio of the first mixed conductor to the second mixed conductor is about 7:3 to about 3:7 by weight.

10. The electrode of claim 1,
wherein in an X-ray diffraction spectrum of the composite conductor, a peak position of the composite conductor is distinguishable from a peak position of the first mixed conductor and a peak position of the second mixed conductor.

11. The electrode of claim 1,
wherein the first metal oxide comprises: a first-1 element and a first-2 element that occupy cuboctahedral sites of the perovskite structure; and
(i). a first-3 element and a first-4 element that occupy octahedral sites of the perovskite structure, or
(ii). a first-3 element, a first-4 element, and a first-5 element that occupy octahedral sites of the perovskite structure,
wherein the first-1 element and the first-2 element are each an element belonging to Group 2 of the Periodic Table and having an atomic weight of 30 or more,
the first-3 element is an element belonging to Group 9 of the Periodic Table,
the first-4 element and the first-5 element are each an element belonging to Groups 3 to 8 or Groups 10 to 12 of the Periodic Table, and
in case of (i) a content of the first-4 element, as a molar ratio, is 0.5 or less based on a total content of the first-3 element and the first-4 element, and
in case of (ii) a content of each of the first-4 and the first-5 element, as a molar ratio, is 0.5 or less based on a total content of the first-3 element, the first-4 element, and the first-5 element.

12. The electrode of claim 1,
wherein the first metal oxide is represented by Formula 1:
M1ₐ₁M2_{b1}M3_{c1}M4_{d1}M5ₑ₁O_{3-δ} Formula 1
wherein, in Formula 1,
0.01≤a1≤0.8, 0.01≤b1≤0.8, 0.5≤c1≤0.9, 0.1≤d1≤0.3, 0≤e1≤0.2, and 0≤δ<1,
M1 and M2 are each independently an element belonging to Group 2 of the Periodic Table and having an atomic weight of 30 or more,
M3 is an element belonging to Group 9 of the Periodic Table,
M4 and M5 are each independently an element belonging to Groups 3 to 8 or Groups 10 to 12 of the Periodic Table, and
δ is an oxygen vacancy.

13. The electrode of claim 1,
wherein the first metal oxide is represented by Formula 2:
Baₐ₂Sr_{b2}Co_{c2}Fe_{d2}Znₑ₂O_{3-δ} Formula 2
wherein, in Formula 2,
0.1≤a2≤0.8, 0.1≤b2≤0.8, 0.5≤c2≤0.9, 0.1≤d2≤0.3, 0≤e2≤0.2, and 0≤δ<1, and δ is an oxygen vacancy.

14. The electrode of claim 1,
wherein the second metal oxide comprises: a second-1 element and a second-2 element that occupy cuboctahedral sites of the perovskite structure; and
(i). a second-3 element that occupy octahedral sites of the perovskite structure, or
(ii). a second-3 element and a second-4 element that occupy octahedral sites of the perovskite structure, and
wherein the second-1 element is an element belonging to Group 3 of the Periodic Table,
the second-2 element is an element belonging to Group 2 of the Periodic Table and having an atomic weight of 30 or more,
the second-3 element is an element belonging to Group 9 of the Periodic Table,
the second-4 element is an element belonging to Groups 3 to 8 or Groups 10 to 12 of the Periodic Table, and
a content of the second-1 element is greater than a content of the second-2 element.

15. The electrode of claim 1,
wherein the second metal oxide is represented by Formula 3:
M6ₐ₃M7_{b3}M8_{c3}M9_{d3}O_{3-δ} Formula 3
wherein, in Formula 3,
0.2≤a3≤0.8, 0.2≤b3≤0.8, 0.1≤c3≤1.0, 0≤d3≤0.9, and 0≤δ<1,
M6 is an element belonging to Group 3 of the Periodic Table,
M7 is an element belonging to Group 2 of the Periodic Table and having an atomic weight of 30 or more,
M8 is an element belonging to Group 9 of the Periodic Table,
M9 is an element belonging to Groups 3 to 8 or Groups 10 to 12 of the Periodic Table, and
δ is an oxygen vacancy.

16. The electrode of claim 1,
wherein the second metal oxide is represented by Formula 4:
Laₐ₄Sr_{b4}CO_{c4}Fe_{d4}O_{3-δ} Formula 4
wherein, in Formula 4,
0.2≤a4≤0.8, 0.2≤b4≤0.8, 0.1≤c4≤1.0, 0≤d4≤0.9, and 0≤δ<1, and δ is an oxygen vacancy.

17. A solid oxide cell comprising:
an air electrode; a fuel electrode; and a solid electrolyte layer disposed between the air electrode and the fuel electrode,
wherein at least one of the air electrode or the fuel electrode comprises a composite conductor,
wherein the composite conductor comprises:
a first mixed conductor containing a first metal oxide having a perovskite structure, and
a second mixed conductor containing a second metal oxide having a perovskite structure,
wherein ionic conductivity of the first mixed conductor is greater than ionic conductivity of the second mixed conductor, and
electronic conductivity of the second mixed conductor is greater than electronic conductivity of the first mixed conductor.

18. The solid oxide cell of claim 17, further comprising a barrier layer disposed between the air electrode and the solid electrolyte layer,
wherein a thermal expansion coefficient of the barrier layer is less than a thermal expansion coefficient of the first mixed conductor or the second mixed conductor.

19. The solid oxide cell of claim 17,
wherein the solid oxide cell is a solid oxide fuel cell or a solid oxide electrolyzer cell.

20. A method of preparing a solid oxide cell, the method comprising:
providing a composition comprising a first metal oxide having a perovskite structure, and a second metal oxide having a perovskite structure;
applying the composition to a surface of a first stack including a fuel electrode and a solid electrolyte layer, the surface with the applied composition adjacent to the solid electrolyte layer to provide a second stack; and
heat-treating the second stack to provide the solid oxide cell, the solid oxide cell comprising an air electrode including a composite conductor, wherein the composite conductor comprises:
a first mixed conductor comprising the first metal oxide; and a second mixed conductor comprising the second metal oxide,
wherein ionic conductivity of the first mixed conductor is greater than ionic conductivity of the second mixed conductor, and
electronic conductivity of the second mixed conductor is greater than electronic conductivity of the first mixed conductor.
